(19) United States
(12) Patent Application Publication
(10) Pub. No.: US 2010/0125043 A1
(43) Pub. Date: May 20, 2010

(54) GLYCAN DATA MINING SYSTEM

(75) Inventors: Ram Sasisekharan, Cambridge, MA (US); S. Raguram, Hillsborough, NJ (US); Mahadevan Venkataraman, Arlington, MA (US); Subramanian Kaundinya, Arlington, MA (US); Rahul Raman, Cambridge, MA (US)

Correspondence Address: CHOATE, HALL & STEWART LLP, TWO INTERNATIONAL PLACE, BOSTON, MA, 02110, US

(73) Assignee: MASSACHUSETTS INSTITUTE OF TECHNOLOGY, Cambridge, MA (US)

(21) Appl. No.: 11/915,194

(22) PCT Filed: Aug. 14, 2007
(86) PCT No.: PCT/US07/18103

§ 371 Date: Jan. 29, 2010

Related U.S. Application Data
(60) Provisional application No. 60/837,869, filed on Aug. 14, 2006.
(60) Provisional application No. 60/837,868, filed on Aug. 14, 2006.

(51) Int. Cl. C40B 30/04

(52) U.S. Cl. 506/9

(57) ABSTRACT

The present invention provides a system for analyzing glycans and their interaction partners. The inventive system is particularly useful in the identification and analysis of glycoprotein binding interactions.

### PRIORITY CLAIM

The present application claims priority under 35 USC 119(e) to co-pending U.S. Provisional patent application Ser. No. 60/837,868, filed on Aug. 14, 2006, and to co-pending U.S. provisional patent application Ser. No. 60/837,869, filed on Aug. 14, 2006. The entire contents of each of these prior applications are incorporated herein by reference.

### GOVERNMENT SUPPORT

This invention was made with United States government support awarded by the National Institute of General Medical Sciences under contract number U54 GM62116 and by the National Institutes of Health under contract number GM57073. The United States Government has certain rights in the invention.

### BACKGROUND OF THE INVENTION

Glycomics, an integrated approach to structure-function relationships of complex carbohydrates or glycans, is emerging as an important paradigm in post-genomics cellular and molecular biology. In the past few years, there has been a dramatic increase in the known biological roles of glycans in fundamental biological processes, such as cell growth and development, tumor growth and metastasis, anticoagulation, immune recognition/response, cell-cell communication, and microbial pathogenesis. Glycans are primary components of the cell surface and the interface between cell and its extracellular environment. As a result, glycans interact with numerous proteins such as growth factors, cytokines, immune receptors, and enzymes, which modulate their activity and thus impinge on the above biological processes.

Therefore, there is a need to identify and/or characterize glycan binding capabilities.

### SUMMARY OF THE INVENTION

The present invention provides a system for analyzing glycans and their interaction partners. The inventive system is particularly useful in the identification and analysis of glycoprotein binding interactions. As described herein, the inventive system has been applied to several different glycoprotein analyses, in each case successfully identifying interaction characteristics. The principles of the inventive system are therefore widely applicable across glycan interactions.

### BRIEF DESCRIPTION OF THE DRAWING

FIG. 1: illustrates the data mining platform utilized herein. Shown in Panel A are the aurin components of the data mining platform. The features are derived from the data objects which are extracted from the database. The features are prepared into datasets that are used by the classification methods to derive patterns or rules. Panel B shows certain software modules that enable the user to apply the data mining process to glycan array data.

FIG. 2: presents a schematic description of features. Shown in Panel A, is a representative high mannose motif to illustrate the definition of pairs, triplets and quadruplets. Shown in Panel B, is a representative O-linked glycan [Core 2] motif to illustrate the different classes of triplets. The following symbol nomenclature was used to represent monosaccharides: Man Gal ▪GlcNAc ▴Fuc ♦Neu5Ac ∘Neu5Gc ♦KDN.

FIG. 3: depicts the classification of high affinity binding. Shown in the Figure is the signal to noise ratio [y axis] of galectin-3 screened against glycans [numbered sequentially in the x axis] in the glycan array. The red dotted line indicates the threshold that was arbitrarily defined to classify glycans that are high affinity binders. These thresholds were defined for each of the GBPs used in the analysis.

FIG. 4: depicts the binding of Lewis^{x} motif containing glycan structure Galβ4 (Fucα3) GlcNAcβ3Gal to CRD of DC-SIGN (ribbon trace in gray). The monosaccharides and linkages are labeled on the glycan structure. Shown in red circle in the 3-OH of the Gal which is close to the glycan binding site. Thus any substitution at this hydroxyl group would have a negative effect on binding consistent with the classifier rule obtained from data mining.

FIG. 5: Alignment of exemplary sequences of wild type HA. Sequences were obtained from the NCBI influenza virus sequence database (http://www.ncbi.nlm.nih.gov/genomes/FLU/FLU.html)

FIG. 6. Framework for understanding glycan receptor specificity. α2-3- and/or α2-6-linked glycans can adopt different topologies. According to the present invention, the ability of an HA polypeptide to bind to certain of these topologies confers upon it the ability to mediate infection of different hosts, for example, humans. As illustrated in this figure, the present invention defines two particularly relevant topologies, a “cone” topology and an “umbrella” topology. The cone topology can be adopted by α2-3- and/or α2-6-linked glycans, and is typical of short oligosaccharides or branched oligosaccharides attached to a core (although this topology can be adopted by certain long oligosaccharides). The umbrella topology can only be adopted by α2-6-linked glycans (presumably due to the increased conformational plurality afforded by the extra C5-C6 bond that is present in the α2-6 linkage), and is predominantly adopted by long oligosaccharides or branched glycans with long oligosaccharide branches, particularly containing the motif Neu5Acα2-6Galβ1-3/4GlcNAc—. As described herein, ability of HA polypeptides to bind the umbrella glycan topology, confers binding to human receptors and/or ability to mediate infection of humans.

FIG. 7. Interactions of HA residues with cone vs umbrella glycan topologies. Analysis of HA-glycan co-crystals reveals that the position of Neu5Ac relative to the HA binding site is almost invariant. Contacts with Neu5Ac involve highly conserved residues such as F98, S/T136, W153, H183 and L/I194. Contacts with other sugars involve different residues, depending on whether the sugar linkage is α2-3 or α2-6 and whether the glycan topology is cone or umbrella. For example, in the cone topology, the primary contacts are with Neu5Ac and with Gal sugars. E190 and Q226 play particularly important roles in this binding. This Figure also illustrates other positions (e.g., 137, 145, 186, 187, 193, 222) that can participate in binding to cone structures. In some cases, different residues can make different contacts with different glycan structures. The type of amino acid in these positions can influence ability of an HA polypeptide to bind to receptors with different modification and/or branching patterns in the glycan structures. In the umbrella topology, contacts are made with sugars beyond Neu5Ac and Gal. This Figure illustrates residues (e.g., 137, 145, 156, 159, 186, 187, 189, 190, 192, 193, 196, 222, 225, 226) that can participate in binding to umbrella structures. In some cases, different residues can make different contacts with different glycan structures. The type of amino acid in these positions can influence ability of an HA polypeptide to bind to receptors with different modification and/or branching patterns in the glycan structures. In some embodiments, a D residue at position 190 and/or a D residue at position 225 contributes to binding to umbrella topologies.

FIG. 8. Exemplary cone topologies. This Figure illustrates certain exemplary (but not exhaustive) glycan structures that adopt cone topologies.

FIG. 9. Exemplary umbrella topologies. This Figure illustrates certain exemplary (but not exhaustive) glycan structures that adopt umbrella topologies.

FIG. 10. Sequence alignment of HA glycan binding domain. Gray: conserved amino acids involved in binding to sialic acid. Red: particular amino acids involved in binding to Neu5Acα2-3/6Gal motifs. Yellow: amino acids that influence positioning of Q226 (137, 138) and E190 (186, 228). Green: amino acids involved in binding to other monosaccharides (or modifications) attached to Neu5Acα2-3/6Gal motif. The sequence for ASI30, APR34, ADU63, ADS97 and Viet04 were obtained from their respective crystal structures. The other sequences were obtained from SwissProt (http://us.expasy.org). Abbreviations: ADA76, A/duck/Alberta/35/76 (H1N1); ASI30, A/Swine/Iowa/30 (H1N1); APR34, A/Puerto Rico/8/34 (H1N1); ASC18, A/South Carolina/1/18 (H1N1), AT91, A/Texas/36/91 (H1N1); ANY18, A/New York/1/18 (H1N1); ADU63, A/Duck/Ukraine/1/63 (H3N8); AAI68, A/Aichi/2/68 (H3N2); AM99, A/Moscow/10/99 (H3N2); ADS97, A/Duck/Singapore/3/97 (H5N3); Viet04, A/Vietnam/1203/2004 (H5N1).

FIG. 11. Sequence alignment illustrating conserved subsequences characteristic of H1 HA.

FIG. 12. Sequence alignment illustrating conserved subsequences characteristic of H3 HA.

FIG. 13. Sequence alignment illustrating conserved subsequences characteristic of H5 HA.

FIG. 14. Conformational map and solvent accessibility of Neu5Acα2-3Gal and Neu5Acα2-6Gal motifs. Panel A shows the conformational map of Neu5Acα2-3Gal linkage. The encircled region 2 is the trans conformation observed in the APR34_H1_{—}23, ADU63_H3_{—}23 and ADS97_H5_{—}23 co-crystal structures. The encircled region 1 is the conformation observed in the AAI68_H3_{—}23 co-crystal structure. Panel B shows the conformational map of Neu5Acα2-6Gal where the cis-conformation (encircled region 3) is observed in all the HA-α2-6 sialylated glycan co-crystal structures. Panel C shows difference between solvent accessible surface area (SASA) of Neu5Acα2-3 and α2-6 sialylated oligosaccharides in the respective HA-glycan co-crystal structures. The red and cyan bars respectively indicate that Neu5Ac in α2-6 (positive value) or α2-3 (negative value) sialylated glycans makes more contact with glycan binding site. Panel D shows difference between SASA of NeuAc in α2-3 sialylated glycans bound to swine and human H1 (H1_{α2-3}), avian and human H3 (H3_{α2-3}), and of NeuAc in α2-6 sialylated glycans bound to swine and human H1 (H1_{α2-6}). The negative bar in cyan for H3_{α2-3} indicates lesser contact of the human H3 HA with Neu5Acα2-3Gal compared to that of avian H3. Torsion angles—φ: C2-C1-O-C3 (for Neu5Acα2-3/6 linkage); ψ: C1-O-C3-H3 (for Neu5Acα2-3Gal) or C1-O-C6-C5 (for Neu5Acα2-6Gal); ω: O-C6-C5-H5 (for Neu5Acα2-6Gal) linkages. The φ, ψ maps were obtained from GlycoMaps DB (http://www.glycosciences.de/modeling/glycomapsdb/) which was developed by Dr. Martin Frank and Dr. Claus-Wilhelm von der Lieth (German Cancer Research Institute, Heidelberg, Germany). The coloring scheme from high energy to low energy is from bright red to bright green, respectively.

FIG. 15. Residues involved in binding of H1, H3 and H5 HA to α2-3/6 sialylated glycans. Panels A-D show the difference (Δ in the abscissa) in solvent accessible surface area (SASA) of residues interacting with α2-3 and α2-6 sialylated glycans, respectively, in ASI30_H1, APR34_H1, ADU63_H3 and ADS97_H5 co-crystal structures. Green bars correspond to residues that directly interact with the glycan and light orange bars correspond to residues proximal to Glu/Asp190 and Gln/Leu226. Positive value of Δ for the green bars indicates more contact of that residue with α2-6 sialylated glycans whereas a negative value of Δ indicates more contact with α2-3 sialylated glycans. Panel E summarizes in tabular form the residues involved in binding to α2-3/6 sialylated glycans in H1, H3 and H5 HA. Certain key residues involved in binding to α2-3 sialylated glycans are colored blue and certain key residues involved in binding to α2-6 sialylated glycans are colored red.

FIG. 16. Binding of Viet04_H5 HA to biantennary α2-6 sialylated glycan (cone topology). Stereo view of surface rendered Viet04_H5 glycan binding site with Neu5Acα2-6Gal linkage in the extended conformation (obtained from the pertussis toxin co-crystal structure; PDB ID: 1PTO). Lys193 (orange) does not have any contacts with the glycan in this conformation. The additional amino acids potentially involved in binding to the glycan in this conformation are Asn186, Lys222 and Ser227. However, certain contacts observed in the HA binding to the α2-6 sialylated oligosaccharide in the cis-conformation are absent in the extended conformation. Without wishing to be bound by any particular theory, we note that this suggests that the extended conformation may not bind to HA as optimally as the cis-conformation. The structures of branched N-linked glycans where the Neu5Acα2-6Galβ1-4GlcNAcb branch was attached to the Manα1-3Man (PDB ID: 1LGC) and Manα1-6Man (PDB ID: 1ZAG) were superimposed on to the Neu5Acα2-6Gal linkage in the Viet04_H5 HA binding site for both the cis and the extended conformation of this linkage. The superimposition shows that the structure with Neu5Acα2-6Galβ1-4GlcNAc branch attached to Manα1-6Man of the core has unfavorable steric overlaps with the binding site (in both the conformations). On the other hand, the structure with this branch attached to Manα1-3Man of the core (shown in figure where trimannose core is colored in purple) has steric overlaps with Lys193 in the cis-conformation but can bind without any contact with Lys193 in the extended conformation, albeit less optimally.

FIG. 17. Production of WT H1, H3 and H5 HA. Panel A shows the soluble form of HA protein from H1N1 (A/South Carolina/1/1918), H3N2 (A/Moscow/10/1999) and H5N1 (A/Vietnam/1203/2004), run on a 4-12% SDS-polyacrylaminde gel and blotted onto nitrocellulose membranes. H1N1 HA was probed using goat anti-Influenza A antibody and anti-goat IgG-HRP. H3N2 was prodes using ferret anti-H3N2 HA antisera and anti-ferret-HRP. H5N1 was probed using anti-avian H5N1 HA antibody and anti-rabbit IgG-HRP. H1N1 HA and H3N2 HA are present as HA0, while H5N1 HA is present as both HA0 and HA1. Panel B shows full length H5N1 HA and two variants (Glu190Asp, Lys193Ser, Gly225Asp, Gln226Leu, “DSDL” and GLu190Asp Lys193Ser Gln223Leu Gly228Ser “DSLS”) run on an SDS-polyacrylamide gel and blotted onto a nitrocellulose membrane. The HA was probed with anti-avian H5N1 antibody and anti-rabbit IgG-HRP.

FIG. 18. Lectin staining of upper respiratory tissue sections. A co-stain of the tracheal tissue with Jacalin (green) and ConA (red) reveals a preferential binding of Jacalin (binds specifically to O-linked glycans) to goblet cells on the apical surface of the trachea and conA (binds specifically to N-linked glycans) to the ciliated tracheal epithelial cells. Without wishing to be bound by any particular theory, we note that this finding suggests that goblet cells predominantly express O-linked glycans while ciliated epithelial cells predominantly express N-linked glycans. Co-staining of trachea with Jacalin and SNA (red; binds specifically to α2-6) shows binding of SNA to both goblet and ciliated cells. On the other hand, co-staining of Jacalin (green) and MAL (red), which specifically binds to α2-3 sialylated glycans, shows weak minimal to no binding of MAL to the pseudostratified tracheal epithelium but extensive binding to the underlying regions of the tissue. Together, the lectin staining data indicated predominant expression and extensive distribution of α2-6 sialylated glycans as a part of both N-linked and O-linked glycans respectively in ciliated and goblet cells on the apical side of the tracheal epithelium.

FIG. 19. Binding of recombinant wild type and mutant HA to tissue sections. Shown are wild type (WT), DSLS, and DSDL binding to trachea, bronchus and alveolus tissue sections. For WT, the white arrow shows HA binding (green) to the alveolar tissue section. For DSLS mutant, the white arrow for the tracheal and bronchial tissue sections shows this mutant HA binding (green) to the apical side of the tissues. Note that the DSDL mutant does not bind to any tissue sections.

### DEFINITIONS

Affinity: As is known in the art, “affinity” is a measure of the tightness with a particular ligand (e.g., an HA polypeptide) binds to its partner (e.g., and HA receptor). Affinities can be measured in different ways.

Biologically active: As used herein, the phrase “biologically active” refers to a characteristic of any agent that has activity in a biological system, and particularly in an organism. For instance, an agent that, when administered to an organism, has a biological effect on that organism, is considered to be biologically active. In particular embodiments, where a protein or polypeptide is biologically active, a portion of that protein or polypeptide that shares at least one biological activity of the protein or polypeptide is typically referred to as a “biologically active” portion.

Broad spectrum human-binding (BSHB) H5 HA polypeptides: As used herein, the phrase “broad spectrum human-binding H5 HA” refers to a version of an H5 HA polypeptide that binds to HA receptors found in human epithelial tissues, and particularly to human HA receptors having α2-6 sialylated glycans. Moreover, inventive BSHB H5 HAs bind to a plurality of different α2-6 sialylated glycans. In some embodiments, BSHB H5 HAs bind to a sufficient number of different α2-6 sialylated glycans found in human samples that viruses containing them have a broad ability to infect human populations, and particularly to bind to upper respiratory tract receptors in those populations. In some embodiments, BSHB H5 HA bind to umbrella glycans (e.g., long α2-6 sialylated glycans) as described herein.

Characteristic portion: As used herein, the phrase a “characteristic portion” of a protein or polypeptide is one that contains a continuous stretch of amino acids, or a collection of continuous stretches of amino acids, that together are characteristic of a protein or polypeptide. Each such continuous stretch generally will contain at least two amino acids. Furthermore, those of ordinary skill in the art will appreciate that typically at least 5, 10, 15, 20 or more amino acids are required to be characteristic of a protein. In general, a characteristic portion is one that, in addition to the sequence identity specified above, shares at least one functional characteristic with the relevant intact protein.

Characteristic sequence: A “characteristic sequence” is a sequence that is found in all members of a family of polypeptides or nucleic acids, and therefore can be used by those of ordinary skill in the art to define members of the family.

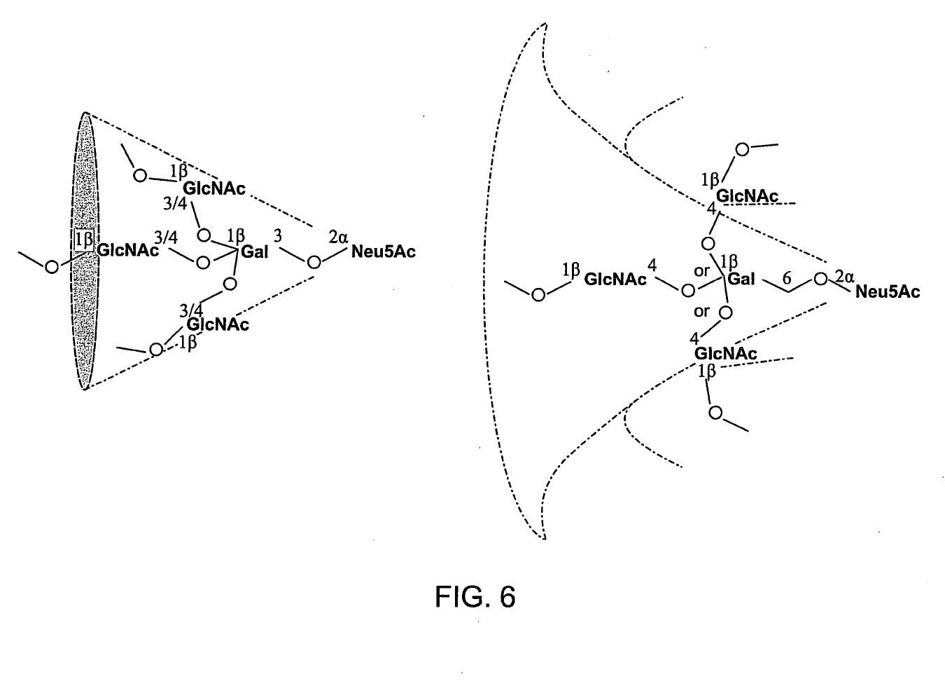

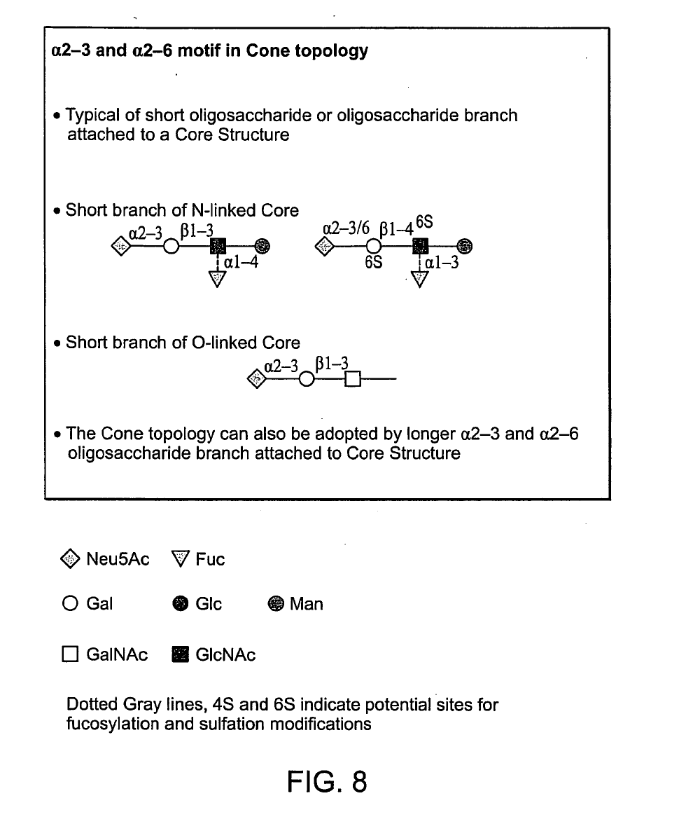

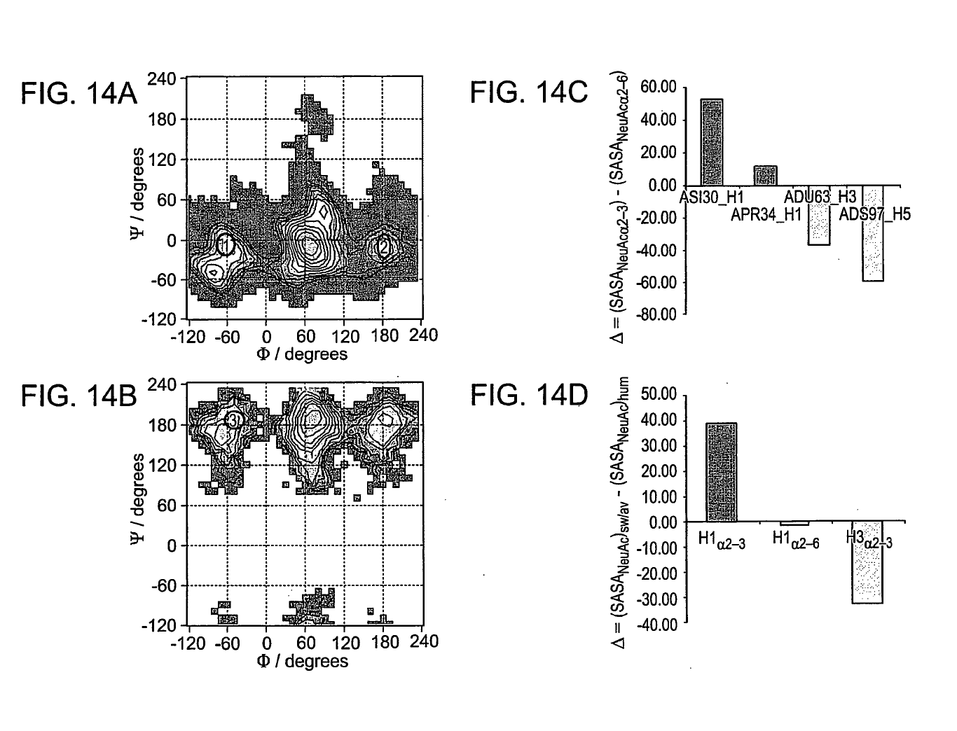

Cone topology: The phrase “cone topology” is used herein to refer to a 3-dimensional arrangement adopted by certain glycans and in particular by glycans on HA receptors. As illustrated in FIG. 6, the cone topology can be adopted by α2-3 sialylated glycans or by α2-6 sialylated glycans, and is typical of short oligonucleotide chains, though some long oligonucleotides can also adopt this conformation. The cone topology is characterized by the glycosidic torsion angles of Neu5Acα2-3Gal linkage which samples three regions of minimum energy conformations given by φ (C1-C2-O—C3/C6) value of around −60, 60 or 180 and ψ (C2-O—C3/C6-H3/C5) samples −60 to 60 (FIG. 14). FIG. 8 presents certain representative (though not exhaustive) examples of glycans that adopt a cone topology.

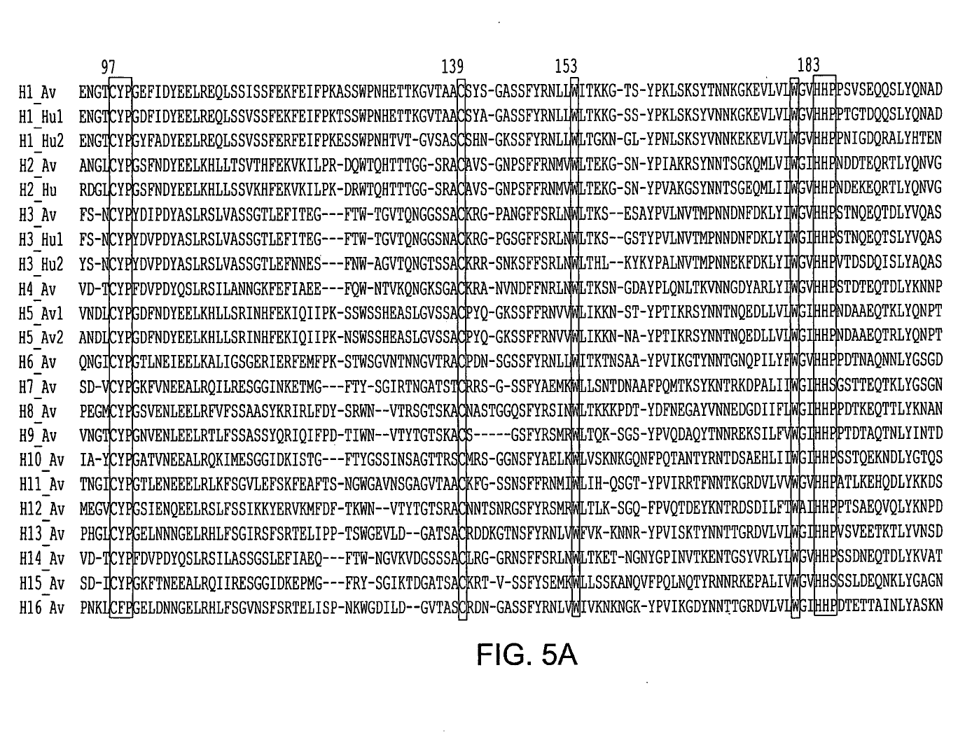

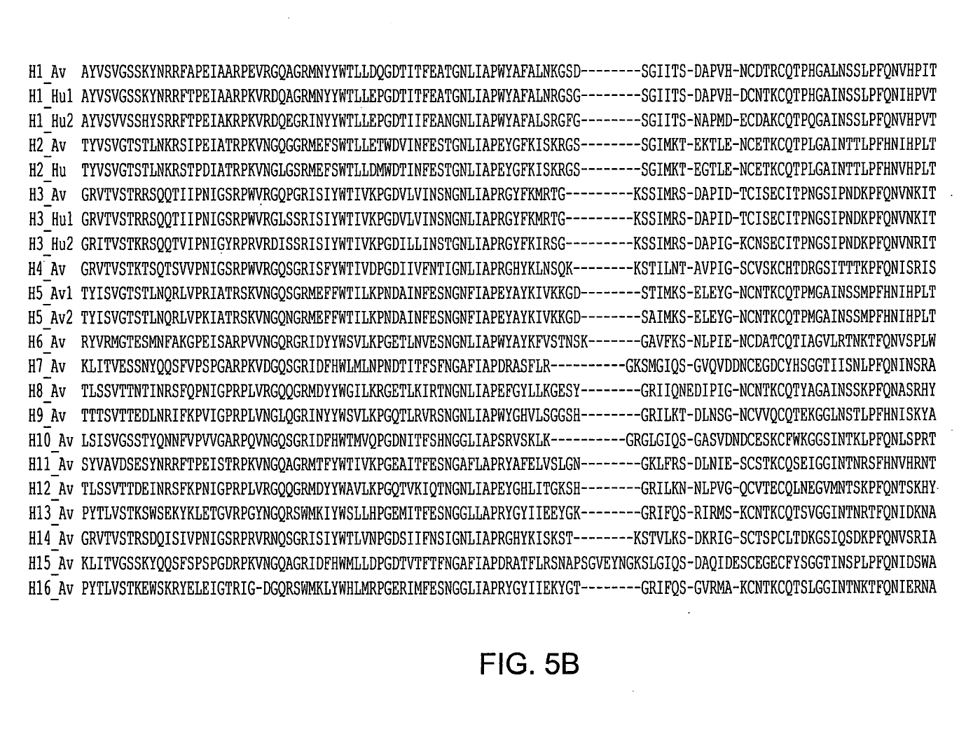

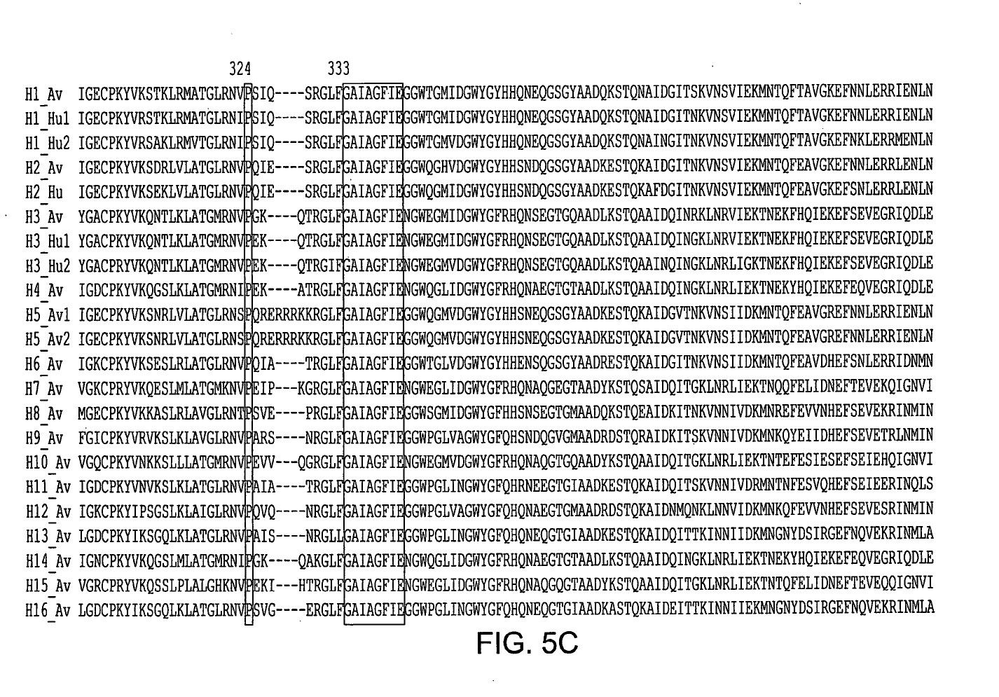

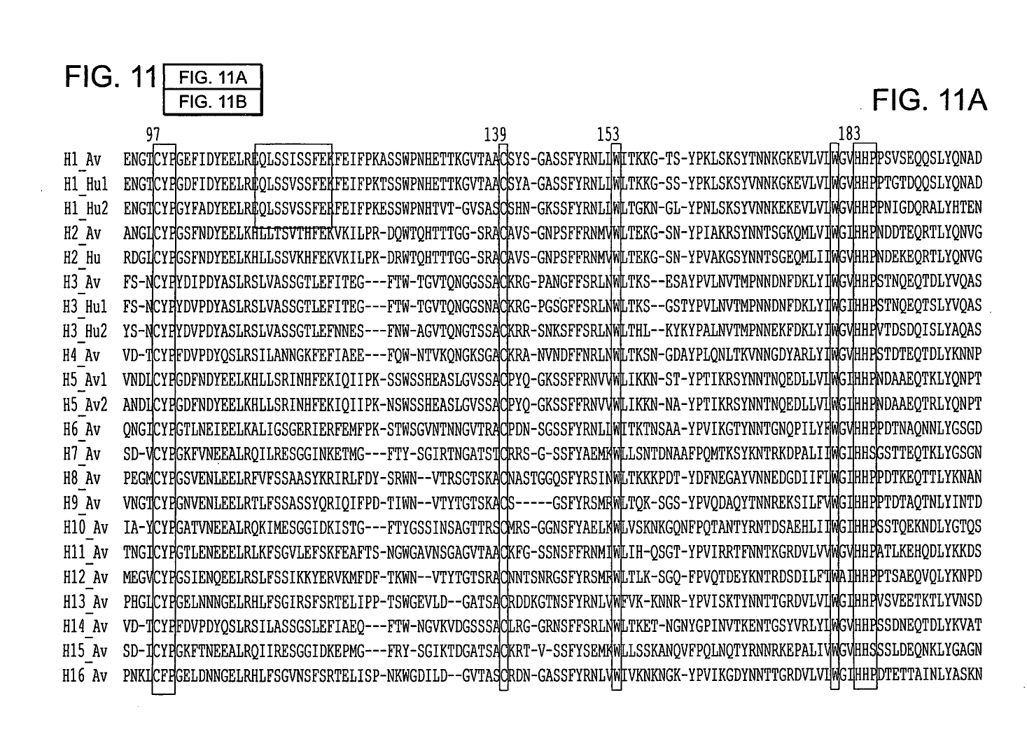

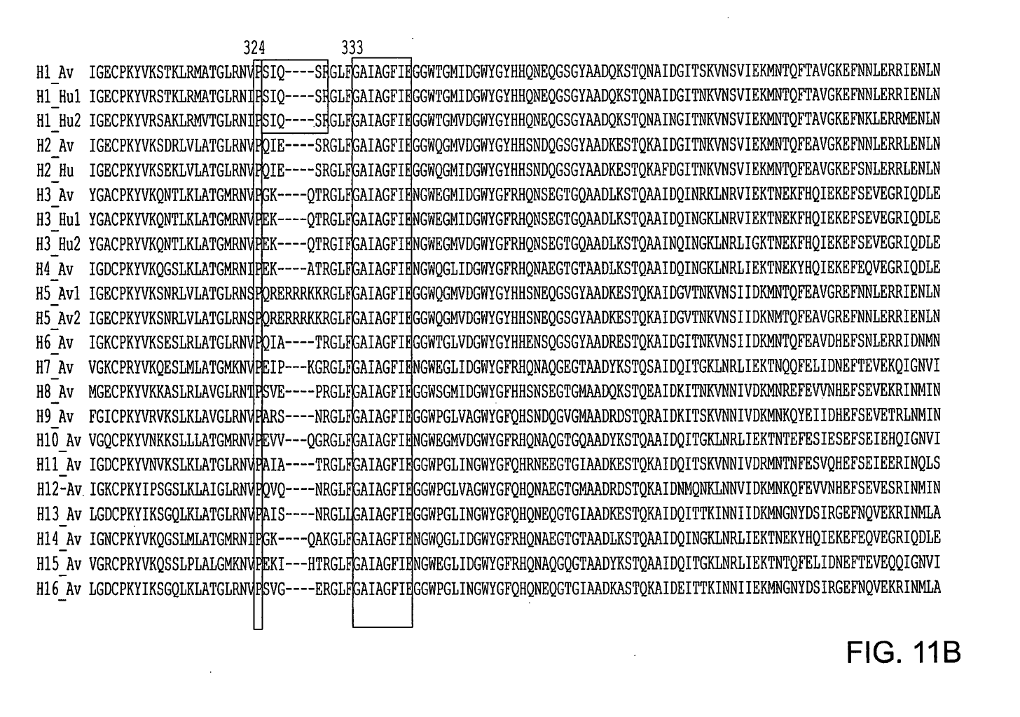

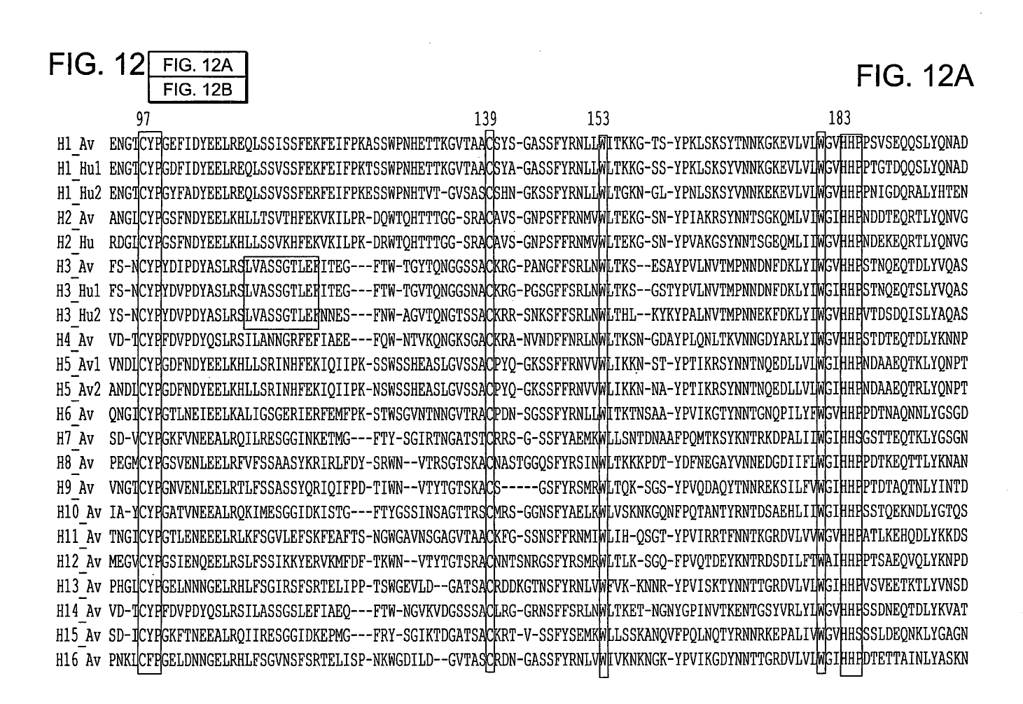

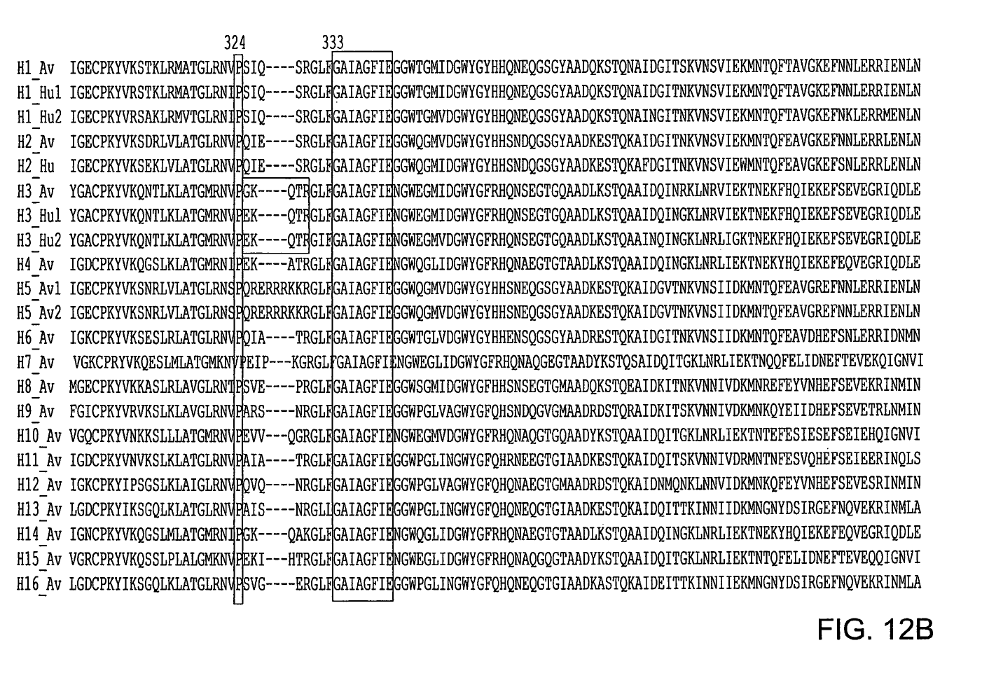

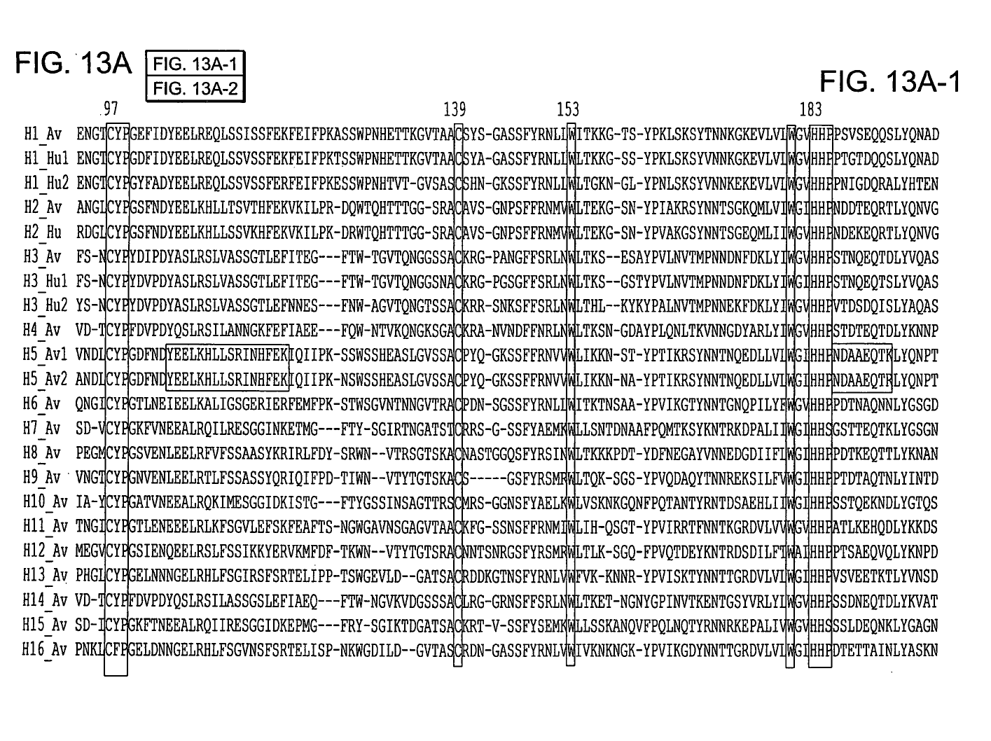

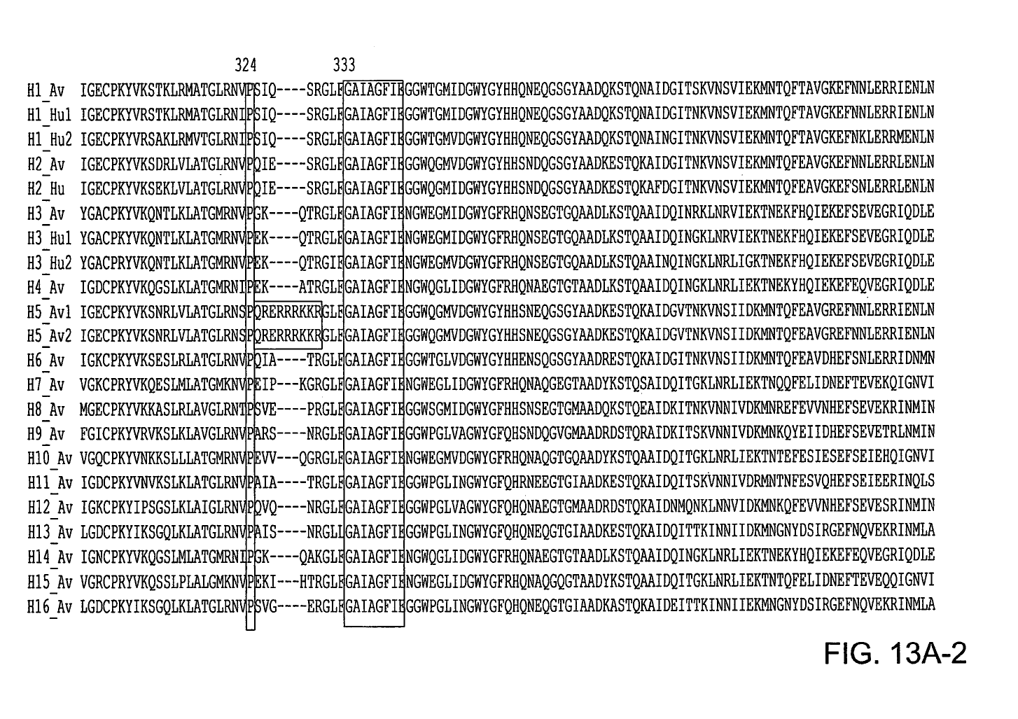

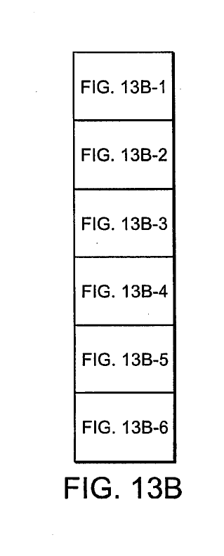

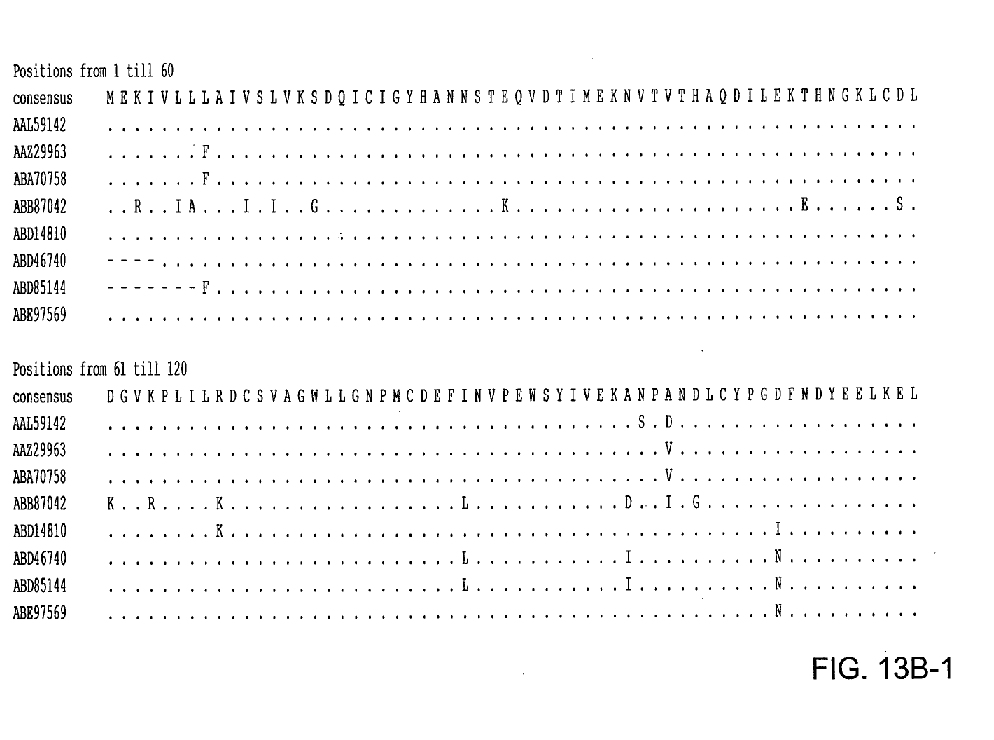

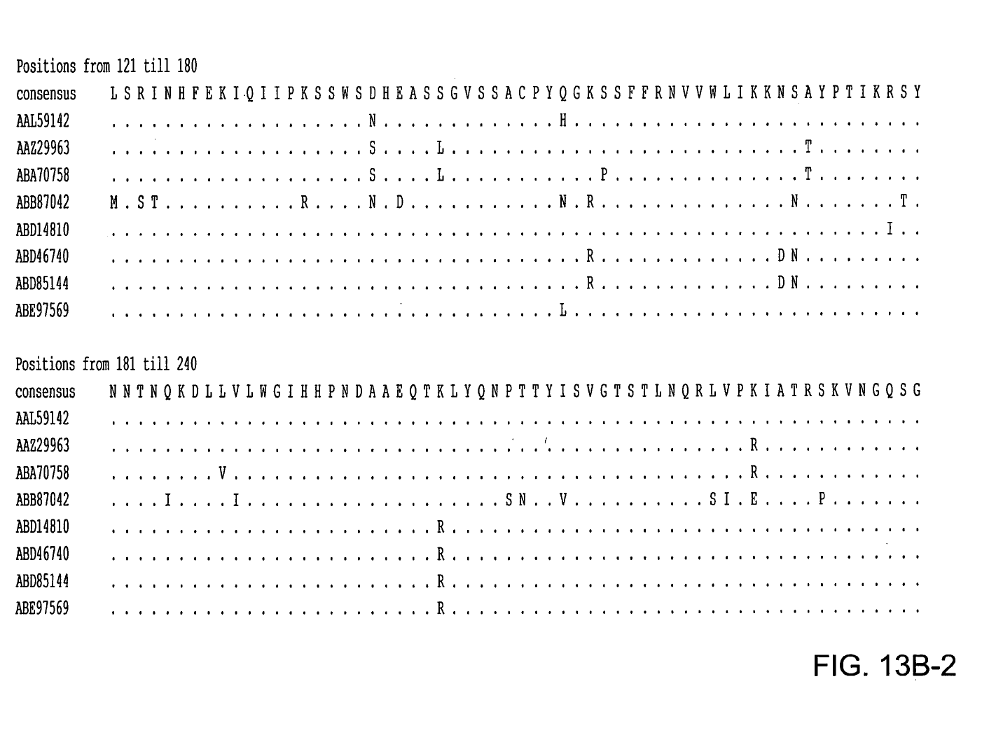

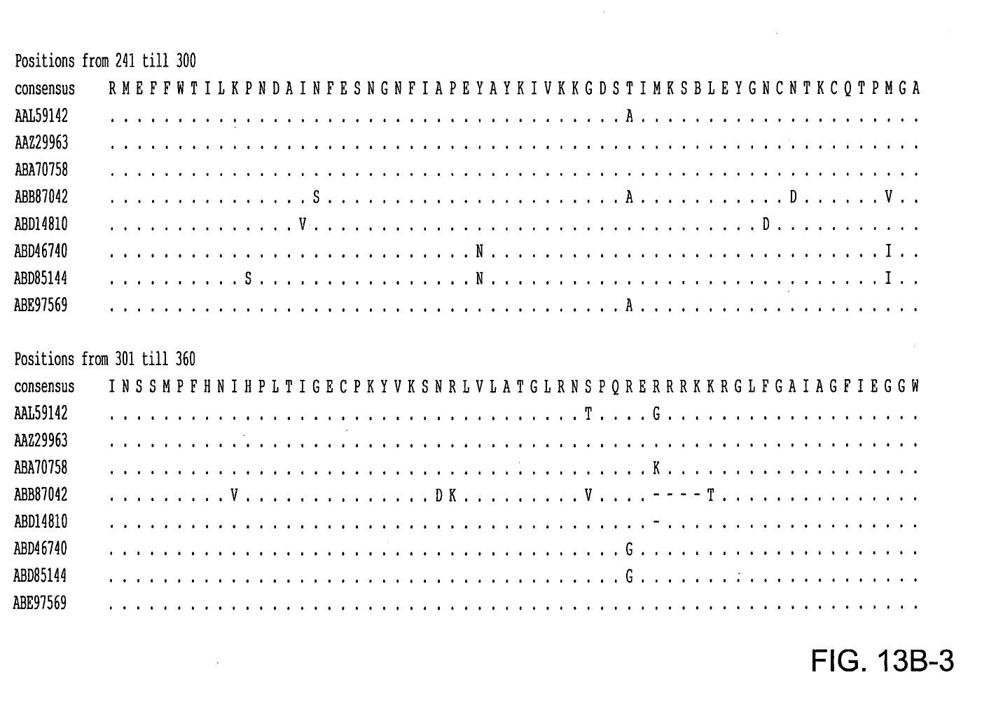

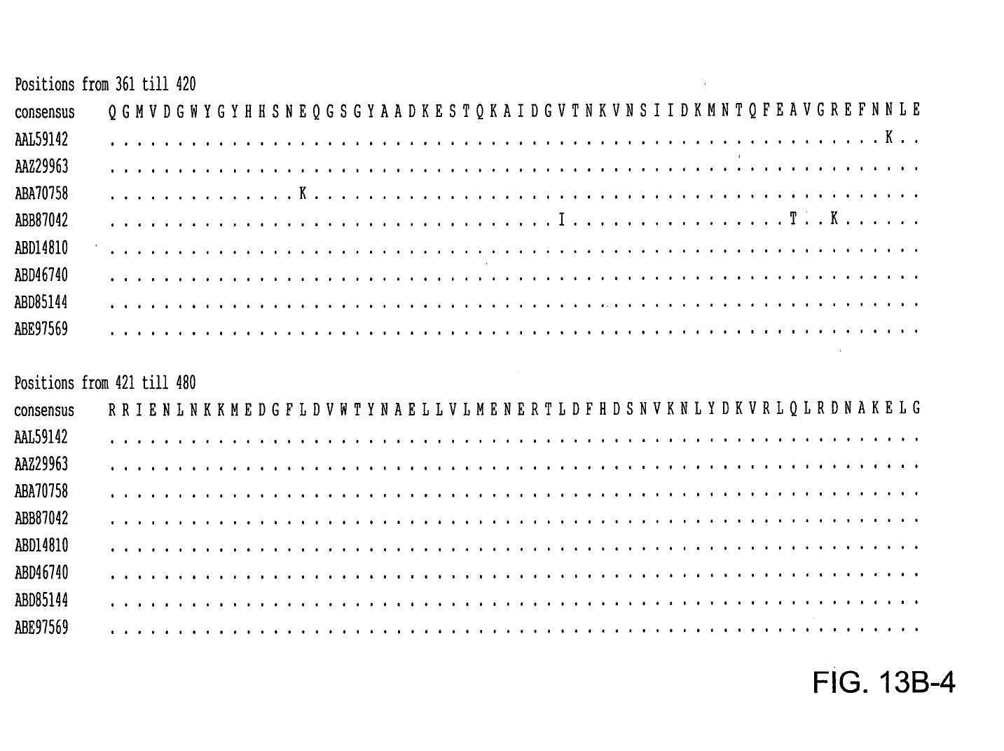

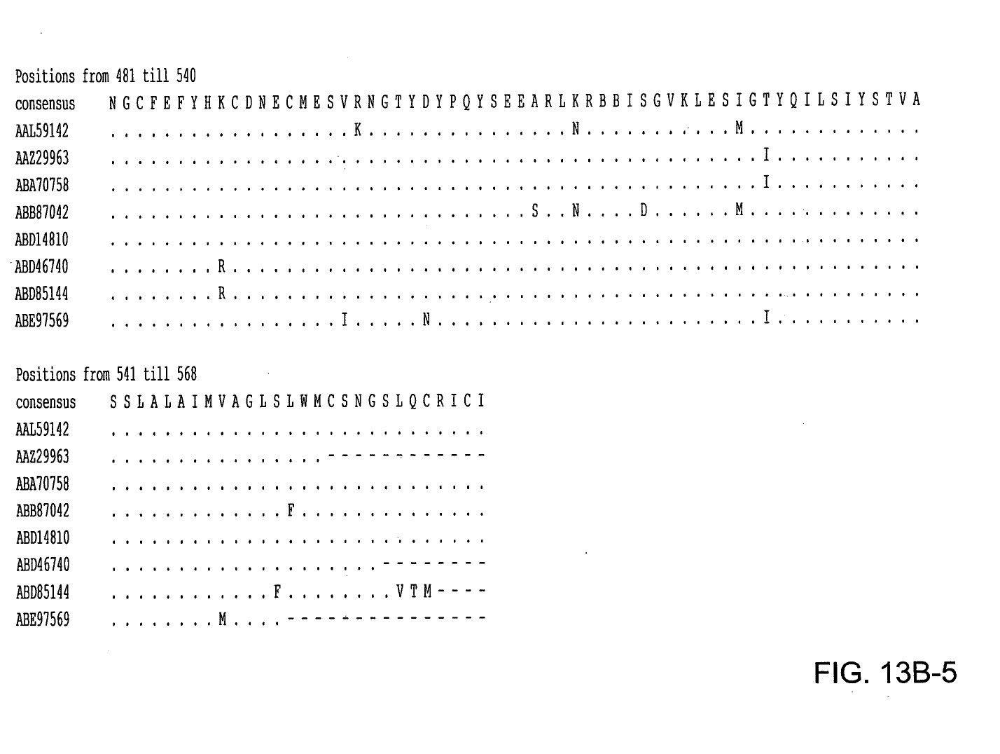

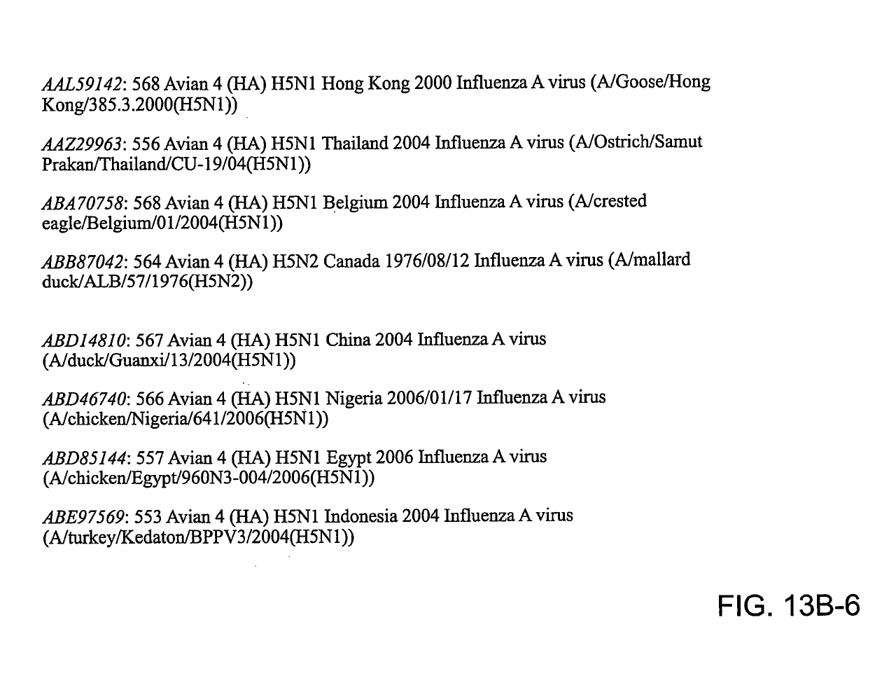

Corresponding to: As used herein, the term “corresponding to” is often used to designate the position/identity of an amino acid residue in an HA polypeptide. Those of ordinary skill will appreciate that, for purposes of simplicity, a canonical numbering system (based on wild type H3 HA) is utilized herein (as illustrated, for example, in FIGS. 5 and 10-13), so that an amino acid “corresponding to” a residue at position 190, for example, need not actually be the 190^{th} amino acid in a particular amino acid chain but rather corresponds to the residue found at 190 in wild type H3 HA; those of ordinary skill in the art readily appreciate how to identify corresponding amino acids.

Degree of separation removed: As used herein, amino acids that are a “degree of separation removed” are HA amino acids that have indirect effects on glycan binding. For example, one-degree-of-separation-removed amino acids may either: (1) interact with the direct-binding amino acids; and/or (2) otherwise affect the ability of direct-binding amino acids to interact with glycan that is associated with host cell HA receptors; such one-degree-of-separation-removed amino acids may or may not directly bind to glycan themselves. Two-degree-of-separation-removed amino acids either (1) interact with one-degree-of-separation-removed amino acids; and/or (2) otherwise affect the ability of the one-degree-of-separation-removed amino acids to interact with direct-binding amino acids, etc.

Direct-binding amino acids: As used herein, the phrase “direct-binding amino acids” refers to HA polypeptide amino acids which interact directly with one or more glycans that is associated with host cell HA receptors.

Engineered: The term “engineered”, as used herein, describes a polypeptide whose amino acid sequence has been selected by man. For example, an engineered HA polypeptide has an amino acid sequence that differs from the amino acid sequences of HA polypeptides found in natural influenza isolates. In some embodiments, an engineered HA polypeptide has an amino acid sequence that differs from the amino acid sequence of HA polypeptides included in the NCBI database.

H1 polypeptide: An “H1 polypeptide”, as that term is used herein, is an HA polypeptide whose amino acid sequence includes at least one sequence element that is characteristic of H1 and distinguishes H1 from other HA subtypes. Representative such sequence elements can be determined by alignments such as, for example, those illustrated in FIGS. 5 and 10-11 and include, for example, those described herein with regard to H1-specific embodiments of HA Sequence Elements.

H3 polypeptide: An “H3 polypeptide”, as that term is used herein, is an HA polypeptide whose amino acid sequence includes at least one sequence element that is characteristic of H3 and distinguishes H3 from other HA subtypes. Representative such sequence elements can be determined by alignments such as, for example, those illustrated in FIGS. 5, 10 and 12 and include, for example, those described herein with regard to H3-specific embodiments of HA Sequence Elements.

H5 polypeptide: An “H5 polypeptide”, as that term is used herein, is an HA polypeptide whose amino acid sequence includes at least one sequence element that is characteristic of H5 and distinguishes H5 from other HA subtypes. Representative such sequence elements can be determined by alignments such as, for example, those illustrated in FIGS. 5, 10, and 13, and include, for example, those described herein with regard to H5-specific embodiments of HA Sequence Elements.

Hemagglutinin (HA) polypeptide: As used herein, the term “hemagglutinin polypeptide” (or “HA polypeptide’) refers to a polypeptide whose amino acid sequence includes at least one characteristic sequence of HA. A wide variety of HA sequences from influenza isolates are known in the art; indeed, the National Center for Biotechnology Information (NCBI) maintains a database (www.ncbi.nlm.nih.gov/genomes/FLU/flu.html) that, as of the filing of the present application included 9796 HA sequences. Those of ordinary skill in the art, referring to this database, can readily identify sequences that are characteristic of HA polypeptides generally, and/or of particular HA polypeptides (e.g., H1, H2, H3, H4, H5, H6, H7, H8, H9, H10, H11, H12, H13, H14, H15, or H16 polypeptides; or of HAs that mediate infection of particular hosts, e.g., avian, camel, canine, cat, civet, environment, equine, human, leopard, mink, mouse, seal, stone martin, swine, tiger, whale, etc. For example, in some embodiments, an HA polypeptide includes one or more characteristic sequence elements found between about residues 97 and 185, 324 and 340, 96 and 100, and/or 130-230 of an HA protein found in a natural isolate of an influenza virus. In some embodiments, an HA polypeptide has an amino acid sequence comprising at least one of HA Sequence Elements 1 and 2, as defined herein. In some embodiments, an HA polypeptide has an amino acid sequence comprising HA Sequence Elements 1 and 2, in some embodiments separated from one another by about 100-200, or by about 125-175, or about 125-160, or about 125-150, or about 129-139, or about 129, 130, 131, 132, 133, 134, 135, 136, 137, 138, or 139 amino acids. In some embodiments, an HA polypeptide has an amino acid sequence that includes residues at positions within the regions 96-100 and/or 130-230 that participate in glycan binding. For example, many HA polypeptides include one or more of the following residues: Tyr98, Ser/Thr136, Trp153, His183, and Leu/Ile194. In some embodiments, an HA polypeptide includes at least 2, 3, 4, or all 5 of these residues.

Isolated: The term “isolated”, as used herein, refers to an agent or entity that has either (i) been separated from at least some of the components with which it was associated when initially produced (whether in nature or in an experimental setting); or (ii) produced by the hand of man. Isolated agents or entities may be separated from at least about 10%, 20%, 30%, 40%, 50%, 60%, 70%, 80%, 90%, or more of the other components with which they were initially associated. In some embodiments, isolated agents are more than 90%, 91%, 92%, 93%, 94%, 95%, 96%, 97%, 98%, 99% pure.

Long oligosaccharide: For purposes of the present disclosure, an oligosaccharide is typically considered to be “long” if it includes at least one linear chain that has at least four saccharide residues.

Non-natural amino acid: The phrase “non-natural amino acid” refers to an entity having the chemical structure of an amino acid (i.e.,:

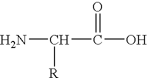

and therefore being capable of participating in at least two peptide bonds, but having an R group that differs from those found in nature. In some embodiments, non-natural amino acids may also have a second R group rather than a hydrogen, and/or may have one or more other substitutions on the amino or carboxylic acid moieties.

Polypeptide: A “polypeptide”, generally speaking, is a string of at least two amino acids attached to one another by a peptide bond. In some embodiments, a polypeptide may include at least 3-5 amino acids, each of which is attached to others by way of at least one peptide bond. Those of ordinary skill in the art will appreciate that polypeptides sometimes include “non-natural” amino acids or other entities that nonetheless are capable of integrating into a polypeptide chain, optionally.

Pure: As used herein, an agent or entity is “pure” if it is substantially free of other components. For example, a preparation that contains more than about 90% of a particular agent or entity is typically considered to be a pure preparation. In some embodiments, an agent or entity is at least 91%, 92%, 93%, 94%, 95%, 96%, 97%, 98%<Or 99% pure.

Short oligosaccharide: For purposes of the present disclosure, an oligosaccharide is typically considered to be “short” if it has fewer than 4, or certainly fewer than 3, residues in any linear chain.

Specificity: As is known in the art, “specificity” is a measure of the ability of a particular ligand (e.g., an HA polypeptide) to distinguish its binding partner (e.g., a human HA receptor, and particularly a human upper respiratory tract HA receptor) from other potential binding partners (e.g., an avian HA receptor).

Therapeutic agent: As used herein, the phrase “therapeutic agent” refers to any agent that elicits a desired biological or pharmacological effect.

Treatment: As used herein, the term “treatment” refers to any method used to alleviate, delay onset, reduce severity or incidence, or yield prophylaxis of one or more symptoms or aspects of a disease, disorder, or condition. For the purposes of the present invention, treatment can be administered before, during, and/or after the onset of symptoms.

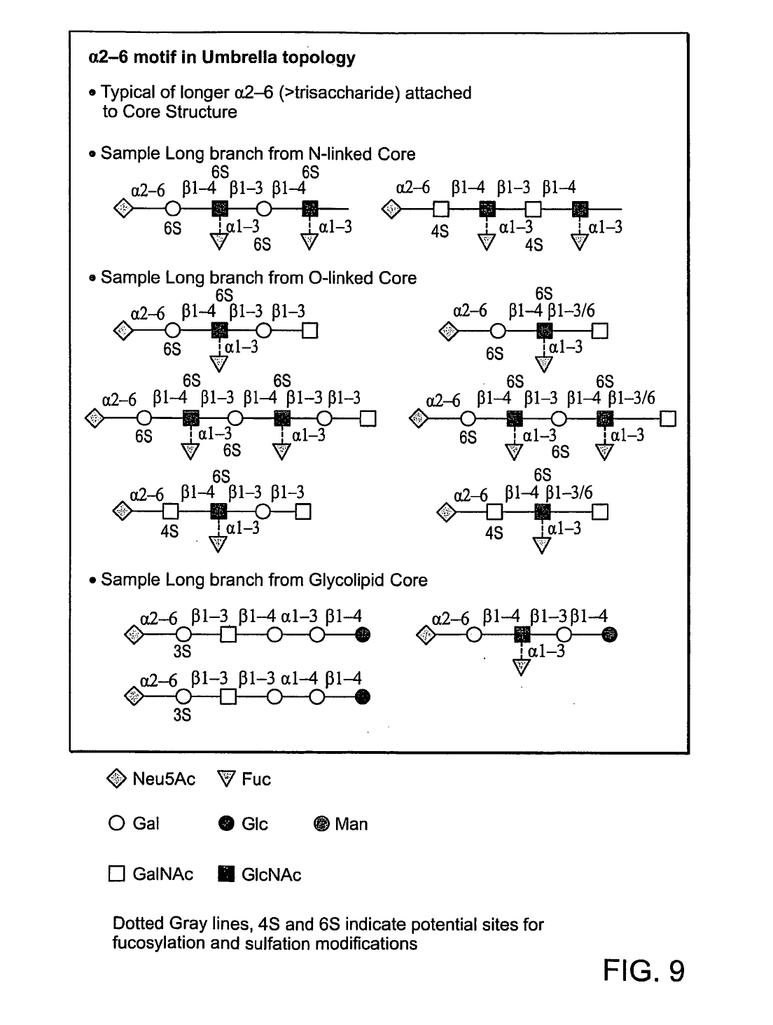

Umbrella topology: The phrase “umbrella topology” is used herein to refer to a 3-dimensional arrangement adopted by certain glycans and in particular by glycans on HA receptors. The present invention encompasses the recognition that binding to umbrella topology glycans is characteristic of HA proteins that mediate infection of human hosts. As illustrated in FIG. 6, the umbrella topology is typically adopted only by α2-6 sialylated glycans, and is typical of long (e.g., greater than tetrasaccharide) oligosaccharides. An example of umbrella topology is given by φ angle of Neu5Acα2-6Gal linkage of around −60 (see, for example, FIG. 14). FIG. 9 presents certain representative (though not exhaustive) examples of glycans that adopt an umbrella topology.

Vaccination: As used herein, the term “vaccination” refers to the administration of a composition intended to generate an immune response, for example to a disease-causing agent. For the purposes of the present invention, vaccination can be administered before, during, and/or after exposure to a disease-causing agent, and in certain embodiments, before, during, and/or shortly after exposure to the agent. In some embodiments, vaccination includes multiple administrations, appropriately spaced in time, of a vaccinating composition.

Variant: As used herein, the term “variant” is a relative term that describes the relationship between a particular HA polypeptide of interest and a “parent” HA polypeptide to which its sequence is being compared. An HA polypeptide of interest is considered to be a “variant” of a parent HA polypeptide if the HA polypeptide of interest has an amino acid sequence that is identical to that of the parent but for a small number of sequence alterations at particular positions. Typically, fewer than 20%, 15%, 10%, 9%, 8%, 7%, 6%, 5%, 4%, 3%, 2% of the residues in the variant are substituted as compared with the parent. In some embodiments, a variant has 10, 9, 8, 7, 6, 5, 4, 3, 2, or 1 substituted residue as compared with a parent. Often, a variant has a very small number (e.g., fewer than 5, 4, 3, 2, or 1) number of substituted functional residues (i.e., residues that participate in a particular biological activity). Furthermore, a variant typically has not more than 5, 4, 3, 2, or 1 additions or deletions, and often has no additions or deletions, as compared with the parent. Moreover, any additions or deletions are typically fewer than about 25, 20, 19, 181, 17, 16, 15, 14, 13, 10, 9, 8, 7, 6, and commonly are fewer than about 5, 4, 3, or 2 residues. In some embodiments, the parent HA polypeptide is one found in a natural isolate of an influenza virus (e.g., a wild type HA).

Vector: As used herein, “vector” refers to a nucleic acid molecule capable of transporting another nucleic acid to which it has been linked. In some embodiment, vectors are capable of extra-chromosomal replication and/or expression of nucleic acids to which they are linked in a host cell such as a eukaryotic or prokaryotic cell. Vectors capable of directing the expression of operatively linked genes are referred to herein as “expression vectors.”

Wild type: As is understood in the art, the phrase “wild type” generally refers to a normal form of a protein or nucleic acid, as is found in nature. For example, wild type HA polypeptides are found in natural isolates of influenza virus. A variety of different wild type HA sequences can be found in the NCBI influenza virus sequence database, http://www.ncbi.nlm.nih.gov/genomes/FLU/FLU.html.

### DETAILED DESCRIPTION OF CERTAIN PARTICULAR EMBODIMENTS OF THE INVENTION

### Defining and Characterizing Glycan-GBP Interactions

An important family of proteins, often referred to as glycan binding proteins (GBPs), bind to N-linked and O-linked glycans on various glycoproteins and mediate cell-cell adhesion, signaling and trafficking events in immune responses. The main classes of GBPs include C-type lectins, galectins and siglecs. GBPs are typically either expressed as soluble or membrane bound proteins in the monomeric or multimeric forms with multiple glycan binding sites. Also, GBPs can be dispersed on the cell surface or localized in a microenvironment.

The glycan binding site in a GBP is also known as a carbohydrate recognition domain (CRD). CRDs on GBPs typically accommodate mono-tetrasaccharide glycan ligand motifs. The interaction between a single CRD and a glycan motif is typically low affinity with values in μM range. However, most of the physiological glycan-GBP interactions are multivalent involving binding of an ensemble of glycan motifs to multimeric CRDs formed by association of GBPs. Thus, unlike protein-protein interactions which either activate or inhibit protein function (digital regulation), glycan-GBP interactions fine tune (analog modulation) protein function through avidity, graded affinity and multivalency.

Decoding structure-function relationships of glycan-protein interactions in the context of biochemical pathways leading to biological function presents unique challenges. One aspect of these challenges arises from the heterogeneity and chemical diversity of glycans due to their non-template biosynthesis involving coordinated expression of multiple glycosyltransferases, some of which have additional tissue specific isoforms. Furthermore, given their biosynthesis and cellular location such as multiple glycosylation sites on proteins, glycans should usually be considered as a heterogeneous mixture of different chemical structures when isolated from cells and tissues. The non-template nature of glycan biosynthesis has also made it challenging to amplify specific glycan structures from biological sources.

Many advances have been made to address the above challenges. Important developments in chemical synthesis strategies have led to synthesis of hundreds of glycan structures which capture the diversity of the glycans present at the cell surface. Using these strategies, different morphologies of glycan motifs viz. clusters, dendromers, polymers, etc. have been constructed to match the different types of multivalent associations of glycan binding sites on proteins. These multivalent glycoconjugates have been primarily utilized in competitive assays to assess the relative binding affinities of different GBPs and for designing inhibitors to physiological glycan-GBP interactions. Despite these advances, much less is known on the specificity or recognition of individual physiological glycan motifs by the different GBPs and the selectivity of biological functions modulated by these interactions.

To rapidly expand the current knowledge of known specific glycan-GBP interactions, the Consortium for Functional Glycomics (CFG; www.functionalglycomics.org), an international collaborative research initiative, has developed glycan arrays comprising several glycan structures that have enabled high throughput screening of GBPs for novel glycan ligand specificities. These glycan arrays are continuously being expanded to increase the diversity of glycan motifs to best mimic the physiological diversity of glycans. Most of the glycans on the CFG arrays were derived by chemical and chemoenzymatic synthesis.

The CFG glycan arrays also comprise both monovalent and polyvalent glycan motifs (i.e. attached to polyacrylamide backbone), and are emerging as widely used resources for glycobiologists to discover new glycan ligands for their GBPs of interest. In addition to the glycan array data, the CFG has also been developing state-of-the-art resources to generate diverse datasets ranging from gene expression of glycan biosynthetic enzymes and GBPs to whole organism glycome and phenome analysis.

The public dissemination of CFG datasets via user-friendly interfaces has begun to motivate the development of data mining tools to find interesting patterns or make meaningful predictions by analyzing these complex data sets. Data mining tools are becoming common place in the realm of genomics and proteomics. High throughput data dealing with numerous components (genes and proteins) and their interactions in complex networks representing biochemical pathways are analyzed to make statistically significant correlations and predictions. In the case of glycomics, given the analog nature of glycan-GBP interactions, it is necessary to go beyond a single glycan interacting with a single GBP to understand the common features in an ensemble of structures that govern binding to specific GBPs.

As a first step toward building data mining tools for analysis of high throughput glycomics data, we have taken a novel approach in this study to analyze the CFG glycan array data using rule induction based data mining methodologies. Taking advantage of the flexible software architecture and relational databases of the CFG, we have utilized our approach to identify patterns that govern the ability of an ensemble of glycans to bind to a specific GBP. Using specific examples of three different families of GBPs: (1) DC-SIGN and SIGNR; (2) galectins; and (3) hemagglutinins, we identify specific patterns in glycans on the array that govern the interactions with these proteins. We validate the patterns identified by using crystal structures and by predicting binding levels between GBP and glycans that are not found in the glycan array. These patterns enable, for the first time, understanding of interactions between an ensemble of glycan structures (containing a common set of features) and a given GBP, thereby allowing analysis and definition of structure-function relationships for glycan-GBP interactions.

The present invention therefore provides a system for understanding the structure-function relationships of glycan-GBP interactions. In particular, the invention provides a system for understanding how interactions between an ensemble of glycan structures and multivalent CRDs of GBPs modulate fundamental biological processes. The invention identifies features in glycans or their binding partners that determine the specificity of a given interaction. The invention also defined constraints provided by the features, for example based on analytical information (e.g., from X-ray crystallography, NMR, etc.) Such constraints can be used on their own or, optionally can be coupled with functional or other information. Appropriate functional information can, for example, be obtained from glycan binding studies.

The invention provides computational methods to analyze datasets obtained from glycan arrays such as those developed by the CFG, which are being increasingly utilized for the purpose of identifying novel candidate glycan ligands for different GBPs. As these glycan arrays continue to expand, the value of such computational methods for analyzing the datasets obtained from these arrays and understanding the basis for specificity in glycan-GBP interactions only increases.

For example, using a rule based data mining methodology to analyze the entire glycan array data (including high, medium, low affinity and non-binders), the present invention provides a novel approach to identifying patterns in glycans that have a positive and negative effect on binding to a GBP. One advantage of such a rule based approach is the presentation of the final patterns as a set of straightforward rules which can be easily applied to identify other potential glycans that satisfy these rules.

As described herein, the principles of the present invention were applied to three diverse GBP families to establish proof-of-principle of their effectiveness. In the first example, i.e. DC-SIGN and SIGNR system, the rules gave three broad features for DC-SIGN viz. high mannose, Lewis x [Galb4(Fuca3)GlcNAc] and Fuca4GlcNAc containing motifs and only the high mannose feature for DC-SIGNR. In addition to capturing the common features that governed high affinity binding, the rules also captured features that were detrimental to binding such as absence of any 3-O substitution on the Gal for the Lewis x containing motifs. These negative results were consistent with analysis of the crystal structures of DC-SIGNR, thus highlighting the value of our approach.

In the case of galectins, the rules were more complex. In addition to identifying the main feature (Galb4GlcNAc) required for high affinity ligand binding by galectins 1 and 3, we also determined the role of substitutions to this unit in the context of chain length in governing the interactions with glycan ligands. Similar to the DC-SIGN example, our findings were consistent with the analysis of the crystal structures of galectins. Based on the features, the main difference between glycan binding of galectin-1 and -3 was that galectin-3 preferred linear repeat units of the Galb4GlcNAc rather than these units present in different branches in N-linked glycans. Since galectin-1 typically occurs as a homodimer with noncovalently associated CRDs, it is possible that the presence of Galb4GlcNAc on different branches would enhance high affinity multivalent binding. On the other hand, galectin-3 is a monomer with a N-terminus linker region and would most likely have a preference to linear repeats of the lactosamine unit in comparison with the branched occurrence of these units.

The overall accuracy of our rule based induction approach is good given that the rules accurately identified 80% of the high binders (in case of DC-SIGN) to 100% of the high binders (galectin-3 and DC-SIGNR) and that there were no false positives in all of the cases. Although the glycan array has a diverse set of glycans, it still does not systematically capture the overall diversity of glycans. As a result, there are singleton data points in the screening data, i.e. high affinity glycan structures which do not fall under any specific group defined by a common set of features. Such singleton data points lead to false negatives in our prediction results. It should be observed from Tables 2 and 3, that each of the rules comprise a primary glycan motif that is shared by a set of glycans with high affinity binding. Furthermore, the primary motifs are specified in conjunction with other constraints such as absence of other motifs or chain length requirements.

As a part of the overall process of data mining, additional features based on these primary patterns can be defined and the roles of these features on glycan binding can be further investigated. For example, the location of Galb4GlcNAc in terms of distance from reducing end or non-reducing end and occurrence as a part of a linear chain or branched chain can be defined as additional features to evaluate their effect on binding. Also, additional glycan features that combine all modifications to each monosaccharide such as GalNAc, Gal[3-O—SO₃], Gal[6-O—SO₃] can be combined into a single feature to evaluate the importance of each of these modifications to the binding.

In summary, using CFG glycan array data as a model system, we have outlined an approach to identify rules or patterns in complex datasets that would facilitate their meaningful interpretation. Many large scale glycomics initiatives are positioning their resources to obtain diverse data sets ranging from gene expression of glycan biosynthesis enzymes, GBPs to identifying the repertoire of glycans from specific cell types and tissues isolated from different sources. As these datasets expand, the rule based induction method outlined herein can be utilized to obtain a combination of patterns that would govern gene expression to glycan-GBP interactions and biological functions.

### Applications

The present invention allows detailed characterization of glycan-GBP binding interaction. The invention therefore provides definitions of sets of glycans that do (or do not) interact with a given GBP. The invention thus allows the preparation of GBP-specific glycan arrays, i.e., of arrays containing a set of glycans sufficient to establish or define the presence or identity of a particular GBP.

For example, once the glycan binding characteristics of a particular GBP are defined as provided herein, an array containing glycans that are bound, glycans that are not bound, and/or combinations thereof can be assembled and used, for example, to detect that particular GBP in samples and/or to characterize derivatives of the GBP.

To give one particular example, one of the GBPs whose binding analysis is exemplified below is the hemagglutinin (HA) H5 protein. Generally speaking, HA interacts with the surface of cells by binding to a glycoprotein receptor. Binding of HA to HA receptors is predominantly mediated by N-linked glycans on the HA receptors. Specifically, HA on the surface of flu virus particles recognizes sialylated glycans that are associated with HA receptors on the surface of the cellular host. After recognition and binding, the host cell engulfs the viral cell and the virus is able to replicate and produce many more virus particles to be distributed to neighboring cells.

HA receptors are modified by either α2-3 or α2-6 sialylated glycans near the receptor's HA-binding site, and the type of linkage of the receptor-bound glycan affects the conformation of the receptor's HA-binding site, thus affecting the receptor's specificity for different HA subtypes. Moreover, the present inventors have determined that the topology of the linked glycans (umbrella-like or cone-like) influences the receptor's specificity for different Has.

For example, the glycan binding pocket of avian HA is narrow. According to the present invention, this pocket binds to the trans conformation of α2-3 sialylated glycans, and/or to cone-topology glycans, whether α2-3 or α2-6 linked.

HA receptors in avian tissues, and also in human deep lung and gastrointestinal (GI) tract tissues are characterized by α2-3 sialylated glycan linkages, and furthermore (according to the present invention), are characterized by glycans, including α2-3 sialylated and/or α2-6 sialylated glycans, which predominantly adopt cone topologies.

By contrast, human HA receptors in the bronchus and trachea of the upper respiratory tract are modified by α2-6 sialylated glycans. Unlike the α2-3 motif, the α2-6 motif has an additional degree of conformational freedom due to the C6-C5 bond (Russell et al., Glycoconj J 23:85, 2006). HAs that bind to such α2-6 sialylated glycans have a more open binding pocket to accommodate the diversity of structures arising from this conformational freedom. Moreover, according to the present invention, HAs may need to bind to glycans (e.g., α2-6 sialylated glycans) in an umbrella topology, and particularly may need to bind to such umbrella topology glycans with strong affinity and/or specificity, in order to effectively mediate infection of human upper respiratory tract tissues.

As a result of these spatially restricted glycosylation profiles, humans are not usually infected by viruses containing many wild type avian HAs (e.g., avian H5). Specifically, because the portions of the human respiratory tract that are most likely to encounter virus (i.e., the trachea and bronchi) lack receptors with cone glycans (e.g., α2-3 sialylated glycans, and/or short glycans) and wild type avian HAs typically bind primarily or exclusively to receptors associated with cone glycans (e.g., α2-3 sialylated glycans, and/or short glycans), humans rarely become infected with avian viruses. Only when in sufficiently close contact with virus that it can access the deep lung and/or gastrointestinal tract receptors having umbrella glycans (e.g., long α2-6 sialylated glycans) do humans become infected.

As described herein, the present invention allows identification of a set of glycans that can be used to detect the H5 HA protein and/or to detect variants of the protein that might emerge with altered binding specificity. In particular, such an inventive array can be used to detect any H5 variant or indeed any of HA protein or variant thereof, with an ability to bind to upper respiratory human HA receptors and/or with an ability to bind (optionally with high affinity and/or specificity, preferably with high affinity) to umbrella-topology glycans.

As demonstrated herein, such arrays are useful for the identification and/or characterization of different HA proteins and their glycan-binding characteristics. In certain embodiments, inventive H5 HA variant proteins are tested on such arrays to assess their ability to bind to umbrella-topology (e.g., α2-6 glycans, and particularly long α2-6 glycans), and particularly to assess their ability to bind to multiple such glycans.

Indeed, the present invention provides arrays of umbrella glycans (e.g., α2-6 glycans, and particularly long α2-6 glycans) and optionally cone-topology glycans (e.g., α2-3 sialylated glycans), that can be used to characterize HA binding capabilities and/or as a diagnostic to detect, for example, human-binding HAs. As will be clear to those of ordinary skill in the art, such arrays are useful not only for characterizing or detecting H5 HAs, but indeed for characterizing or detecting any HAs, including for example, H7 and/or H9, whose ability to bind α2-6 glycans is desirably to be assessed.

### EXEMPLIFICATION

### Example 1

### Data Mining Methodologies

### Description of the Glycan Array and Source of Glycan Array Data

The CFG has developed two kinds of glycan arrays: (1) well based microarray and (2) solid phase printed array. The printed array was more recently developed, so most of the initial ligand screening was performed using the well based microarray. The first version of the well-based array developed by the CFG comprised around 60 different glycans with triplicate representations of each glycan. Each successive version of the array incorporated additional glycans, and the current version comprises 195 glycans with quadruplicate representation of each glycan (see http://www.functionalglycomics.orestatic/consortium/resources/resourcecoreh5.shtml). The array predominantly comprises synthetic glycans that capture the physiological diversity of N- and O-linked glycans. The array also comprises polyvalent glycan ligands attached to a polyacrylamide backbone. In addition to the synthetic glycans, N-linked glycan mixtures derived from different mammalian glycoproteins are also represented on the array.

The datasets chosen for analysis in this study were obtained from the CFG web site at: http://www.functionalglycomics.org/glycomics/publicdata/primaryscreen.jsp. Currently, 40 mammalian GBPs have been screened against different versions of the glycan array. The screening data are available both in the raw format comprising of the intensity signals for a given GBP in a given well, as well as mean signal and signal to noise ratio of the GBP for each glycan ligand on the array. It is important to point out that as the glycan array evolved into its current version; the GBPs that were screened using the earlier version of the array generally were not screened again using the latest version. The absence of these data points has had implications on identification of features that distinguished the binding of glycan ligands from one GBP to another (as discussed herein). The datasets corresponding to the screening of DC-SIGN, -SIGNR, human galectin-1 and galectin-3 (and its individual carbohydrate recognition domains), and hemagglutinin H5 were obtained. These datasets were analyzed using the data mining platform described below.

### Data Mining Platform

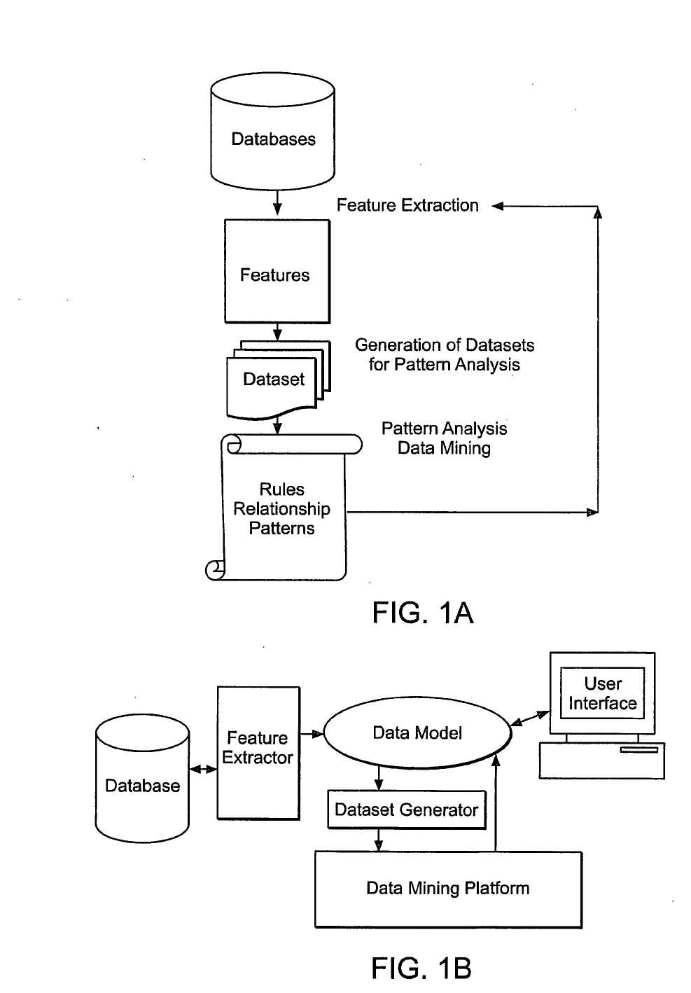

The main steps involved in the data mining process are illustrated in FIG. 1. These steps involve operations on three elements: the data objects, features and classifiers. “Data objects” are the raw data that are stored in the database. In the case of glycan array data, the chemical description of glycan structures in terms of monosaccharides and linkages and their binding signals with different GBPs screened constitute the data objects. Important properties of the data objects are “features.” The choice of features to describe a data object allows the rules or patterns to be obtained. “Classifiers” are the rules or patterns that are used to either cluster data objects into specific classes or determine relationships between features. As discussed in our examples below, the classifiers provide specific features that are satisfied by the glycans that bind with high affinity to a GBP. These rules are of two kinds: (1) features present on a set of high affinity glycan ligands, which can be considered to enhance binding, and (2) features that should not be present in the high affinity glycan ligands, which can be considered not favorable for binding.

The data mining platform comprises software modules that interact with each other (FIG. 1) to perform the operations described above. One component is the feature extractor that will interface to the CFG database to extract features. The object based relational database used by CFG facilitates the flexible definition of features.

### Feature Extraction and Data Preparation:

As noted above, features can be extracted from glycans and/or from their binding partners. In the particular applications exemplified herein, certain features were extracted from glycans on the glycan array, as listed in Table 1:

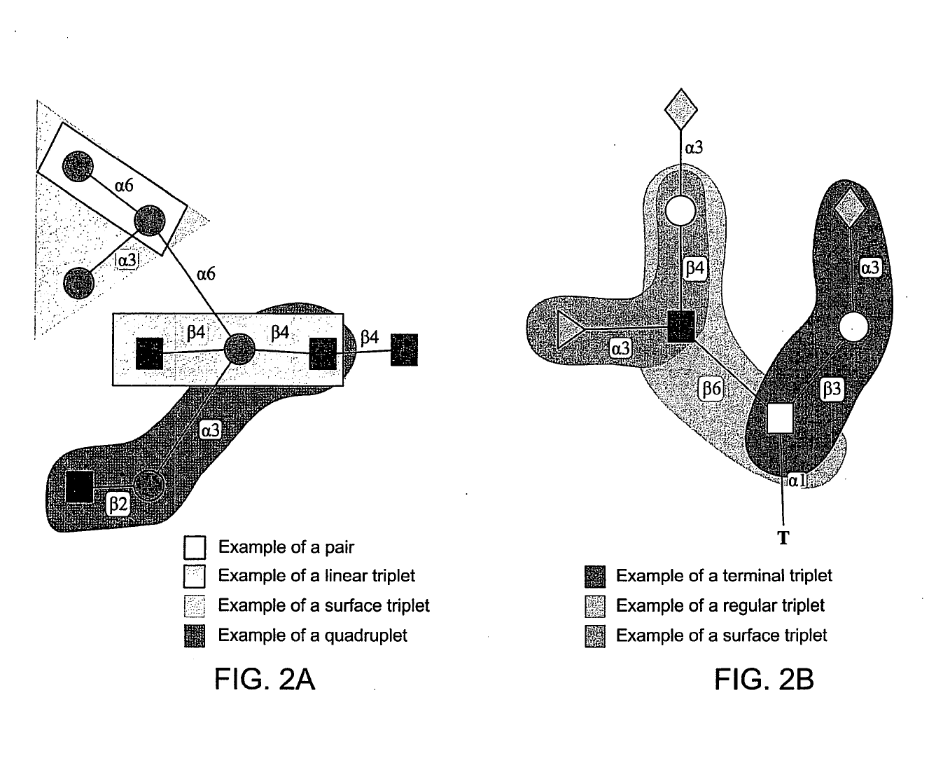

TABLE 1
Features extracted from the glycans on the glycan array.
The features described in this table were used by the rule based classification
algorithm to identify patterns that characterized binding to specific GBP.

| Features extracted | Feature Description |
|---|---|
| Monosaccharide level | |
| Composition | Number of hex, hexNAcs, dHex, sialic acids, etc [In FIG. 1, the |
| | composition is Hex = 5; HexNAc = 4]. Terminal composition is |
| | distinctly recorded [In FIG. 1, the terminal composition is |
| | Hex = 2; HexNAc = 2]. |
| Explicit Composition | Number of Glc, Gal, GlcNAc, Fuc, GalNAc, Neu5Ac, Neu5Gc, etc |
| | [In FIG. 1, the explicit composition is Man = 5; GlcNAc = 4]. |
| | Terminal explicit composition is explicitly recorded [In FIG. 1, the |
| | terminal explicit composition is Man = 2; GlcNAc = 2]. |
| Higher order features | |
| Pairs | Pair refers to a pair of monosaccharide, connected covalently by a |
| | linkage. The pairs are classified into two categories, regular [B] and |
| | terminal [T] to distinguish between the pair with one monosaccharide |
| | that terminates in the non reducing end [FIG. 2]. The frequency of |
| | the pairs were extracted as features |
| Triplets | Triplet refers to a set of three monosaccharides connected covalently |
| | by two linkages. We classify them into three categories namely |
| | regular [B], terminal [T] and surface [S] [FIG. 2]. The |
| | compositions of each category of triplets were extracted as features |
| Quadruplets | Similar to the triplet features, quadruplets features are also extracted, |
| | with four monosaccharides and their linkages [FIG. 2]. Quadruplets |
| | are classified into two varieties regular [B] and surface [S]. The |
| | frequencies of the different quadruplets were extracted as features |
| Clusters | In the case of surface triplets and quadruplets above, if the linkage |
| | information is ignored, we get a set of monosaccharide clusters, and |
| | their frequency of occurrence (composition) is tabulated. These |
| | features were chosen to analyze the importance of types of linkages |
| | between the monosaccharides. |
| Average Leaf Depth | As an indicator of the effective length of the probes, average depth of |
| | the reducing end of the tree is extracted as a glycan feature. In FIG. |
| | 2B, the leaf depths are 3, 4 and 3, and the average is 3.34 |
| Number of Leaves | As a measure of spread of the glycan tree, the number of non |
| | reducing monosaccharides is extracted as a feature. For FIG. 2B, |
| | the number of leaves is 3. For FIG. 1 it is 4. |
| GBP binding features | These features are obtained for all GBPs screened using the array |
| Mean signal per glycan | Raw signal value averaged over triplicate or quadruplicate [depending |
| | on array version] representation of the same glycan |
| Signal to Noise Ratio | Mean noise computed based on negative control [standardized |
| | method developed by CFG] to calculate signal to noise ratio [S/N] |

The rationale behind choosing the features shown was that glycan binding sites on GBPs typically accommodate di-tetra-saccharides. A tree-based representation was used to capture the information on monosaccharides and linkages in the glycan structures (root of the tree at the reducing end). This representation facilitated the abstraction of various features including higher order features such as connected set of monosaccharide triplets, etc (FIG. 2). The data preparation involved generating a column-wise listing of all the glycans in the latest version of the glycan array along with the abstracted features (Table 1) for each glycan. From this master table of glycans and their features, a subset was chosen for the rule based classification (see below) to determine specific patterns that govern the binding to a specific GBP or set of GBPs.

### Classifiers:

Different types of classifiers have been developed and used in many applications. They primarily fall into three main categories: Mathematical methods, Distance methods and Logic Methods. These different methods and their advantages and disadvantages are discussed in detail in Weiss & Indrukhya (Predictive data mining—A practical guide. Morgan Kaufmann, San Francisco, 1998). For this specific application we choose a method called Rule Induction, which falls under Logic Methods. The Rule Induction classifier generates patterns in form of IF-THEN rules.

One of the main advantages of the Logic Methods and specifically classifiers such as the Rule Induction method that generate IF-THEN rules is that the results of the classifiers can be explained more easily when compared to the other statistical or mathematical methods. This allows one to explore the structural and biological significance of the rule or pattern discovered. An example rule generated using the features described earlier (see Table 1) is—

IF A Glycan contains “Galb4GlcNAcb3Gal[B]” and DOES NOT contain “Fuca3GlcNAc[B]”, THEN the Glycan will bind with higher affinity to Galectin 3.

The specific Rule Induction algorithm that was used in this case is the one developed by Weiss & Indurkya (Predictive data mining—A practical guide. Morgan Kaufmann, San Francisco, 1998).

### Binding Levels

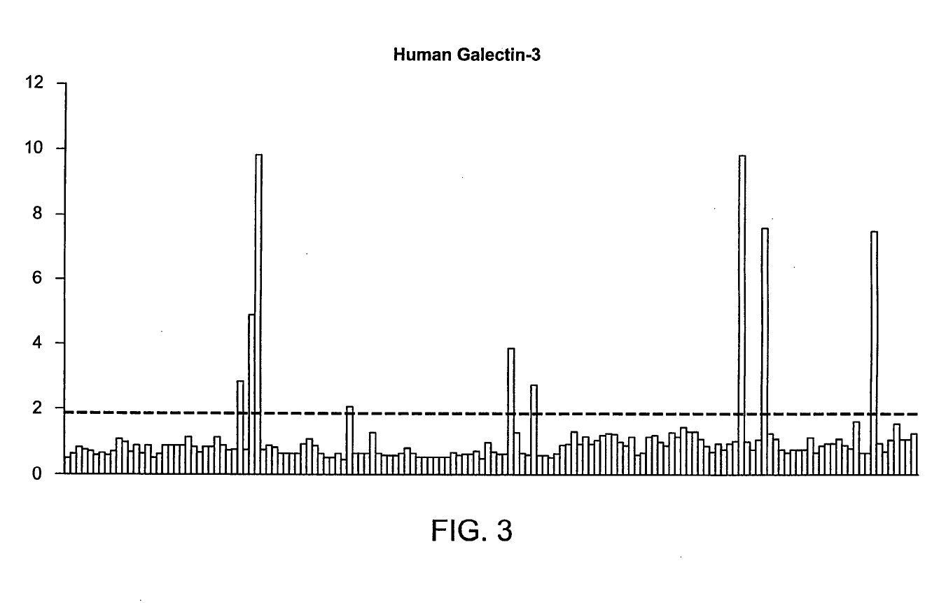

A threshold that distinguished low affinity and high affinity binding was defined for each of the glycan array screening data sets (FIG. 3).

By applying data mining methods to the high throughput CFG glycan array data, we have identified a set of features in glycans that bind to different GBPs. Three specific systems were chosen as examples: (1) DC-SIGN and -SIGNR, (2) galectins; and (3) hemagglutinin H5. Each of these GBP families is reasonably well defined in terms of glycan ligand preferences. The first example provides an additional validation of our methodology since a recent study outlined the structural basis of distinct ligand specificities of DC-SIGN and -SIGNR based on the glycan array data. Earlier studies have systematically evaluated ligand specificities of different galectins. However, the CFG glycan arrays represent a much larger domain of glycan structures that have been used to screen ligand specificities of different galectins. Thus the application of our methodology to the galectin datasets provides additional rules that govern the binding of different galectins to their glycan ligands.

### Example 2

### Application of Methodology to DC-SIGN and DC-SIGNR

DC-SIGN and DC-SIGNR belong to the type II transmembrane receptor subfamily of C-type lectins which recognize and bind to glycan ligands in a Ca²⁺ dependent manner. DC-SIGN is abundantly expressed in dendritic cells, and plays a key role in adhesion of T-cells to the antigen presenting dendritic cells via ICAM-3 molecule, thereby initiating an immune response. In addition, DC-SIGN has also been shown to play an important role in recognition of pathogens such as HIV, etc. by the dendritic cells. In fact, it has been demonstrated that binding of HIV to DC-SIGN on dendritic cells enhances the infection of the T-cells. On the other hand, DC-SIGNR, which shares a 77% sequence identity with DC-SIGN, is found on endothelial cells in liver, lymph nodes and placenta.

Each of these proteins contains a single carbohydrate recognition domain (CRD) at the C-terminus. The extracellular alpha helical domain (adjacent to CRD) on both the proteins facilitates tetramerization of the CRDs, thus enabling multivalent interactions with glycan ligands. There has been a wealth of crystal structure information on DC-SIGN and -SIGNR including crystal structures with different glycan ligands. More recently, these proteins were screened using the CFG glycan arrays and it was demonstrated that they had distinct ligand specificities and signaling properties. Thus, the glycan array data for these proteins provided a good framework to validate the data mining methodology.

As outlined above in Example 1, the glycan features (Table 1) corresponding to glycan screening analysis of DC-SIGN and DC-SIGNR were abstracted from the CFG database. The rule-based classification methods were performed, using these features where the main objective function was the mean signal to noise ratio of binding of each glycan to each of the two proteins. The results from the classification methods are summarized in Table 2:

TABLE 2
Rules that govern glycan binding to DC-SIGN and DC-SIGNR
The rules are derived based on features [Table 1] where #[ ] is used to specify
number of occurrences. The last rule governing DC-SIGN binding is more complex
involving a “&” combination of multiple features which implies that each of the
individual rules must be satisfied. The glycans which could not be clustered into rules
[false negatives] are also shown for DC-SIGN.

| DC-SIGN | | DC-SIGNR | |
|---|---|---|---|
| Glycan Features | True Positives | Glycan Features | True Positives |
| 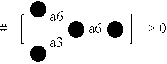 | 6 | 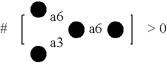 | 6 |
| 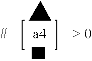 | 4 | | |
| 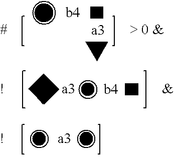 | 6 | | |

| | |
|---|---|
| Summary: | Summary: |
| Threshold S/N ratio = 2.3 | Threshold S/N ratio = 3.43 |
| Total no. of high binders = 20 | Total no. of high binders = 6 |
| True positives = 16 | True positives = 6 |
| False positives = 0 | False positives = 0 |
| False negatives = 4 | False negatives = 0 |
| True negatives = 124 | True negatives = 42 |
| 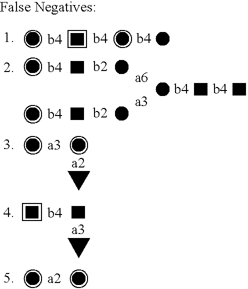 | |

The overall performance of the rule based classification methods was good given that they predicted 100% of the candidate high mannose structures for DC-SIGNR and predicted 16 out of 20 high binders for DC-SIGN. It is significant to note that there were no false positives, in other words there was no instance of a glycan which was predicted to bind, but did not bind. The first obvious implication by looking at the results is that both DC-SIGN and DC-SIGNR share common high affinity binding to high mannose structures. The presence of Mana3(Mana6)Mana6Man is a strong rule that captures 6 different high mannose glycan ligands that bind with high affinity based on the glycan array data. This observation is consistent with the earlier crystal structure studies.

In addition to the high mannose ligands, DC-SIGN bound to an additional set of fucosylated ligands that were characterized by distinct features. These fucosylated ligands did not bind to DC-SIGNR. The Fuca4GlcNAc is a commonly observed motif in Lewis^{a} [Fuca4(Galb3)GlcNAc] containing glycan structures. The Fuca3(Galb4)GlcNAc is another commonly observed Lewis^{x} motif present on the non-reducing terminal of N- and O-linked glycans. Both these features were characteristic of high affinity binders to DC-SIGN. This observation is consistent with the distinct binding of DC-SIGN to fucosylated ligands that was observed in earlier crystal structures of DC-SIGN with Lewis^{X} containing glycan structures. Based on a detailed investigation of crystal structures of DC-SIGN and SIGNR with high mannose and fucosylated ligands, it was shown that while both these proteins shared a similar mode of binding to the high mannose ligand, the binding to the fucosylated ligands was completely different and could be achieved only by the amino acids in the CRD of DC-SIGN.

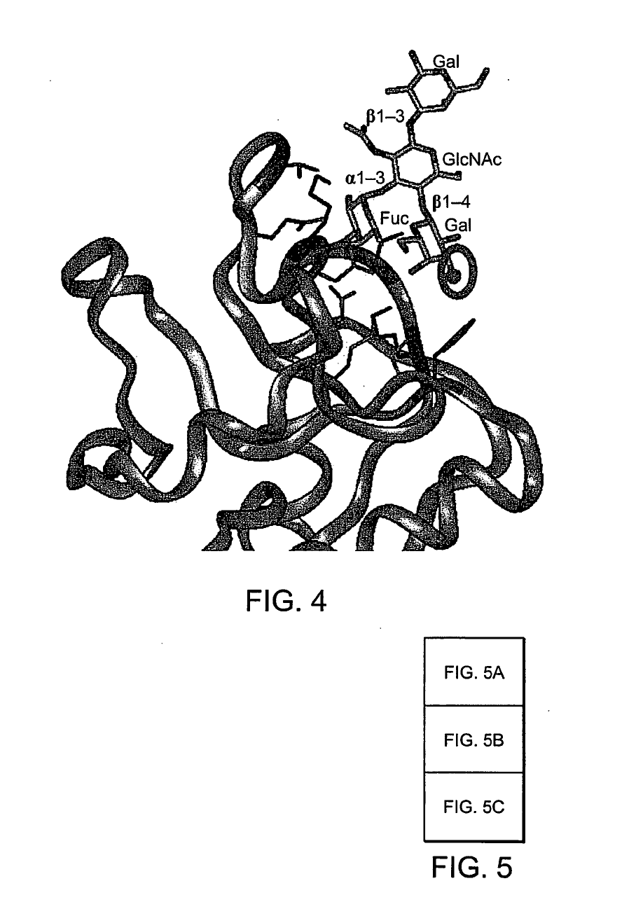

Another interesting observation provided by our analysis is the required absence of specific features for high affinity binding. In other words, the presence of Neua3Galb4GlcNAc and Gala3Gal along with the Lewis^{x} motif would be detrimental to binding of these ligands with DC-SIGN. The value of our data mining approach is highlighted by the confirmation of this rule by investigating the crystal structure of DC-SIGN with the Lewis^{x} containing glycan ligand. Since the 3-OH position of the Gal in Fuca3(Galb4)GlcNAc is close to the CRD of DC-SIGN (FIG. 4), any bulky substitution to this position including sulfation, sialylation, etc. would lead to unfavorable steric contacts with the protein and would thus disrupt binding.

Based on the crystal structure of Lewis^{X} containing glycans with DC-SIGN and -SIGNR, the primary binding of fucosylated ligands involves the equatorial oxygens 3-OH and 4-OH of the Fuc which form coordination with the Ca²⁺ ion. Thus even in the case of Lewis^{a} antigen Fuca4(Galb3)GlcNAc, the primary binding involves the 3, and 4-OH of Fuc (FIG. 4). Interestingly, the rule involving this motif # [Fuca4GlcNAc]>0 did not explicitly include the presence of the Galb3GlcNAc linkage. Thus, the analysis indicates that the presence of Gal has a better effect on binding of DC-SIGN to fucosylated ligands in the case of Lewis^{x} containing motifs than those containing Lewis^{a} containing motifs.

### Example 3

### Application of Methodology to Galectins

Galectins belong to a family of soluble GBPs that are known to bind β-galactosides which were earlier defined as S-type lectins due to their requirement for reducing thiols for their activity. Unlike the C-type lectins (such as DC-SIGN and -SIGNR), galectins do not require Ca²⁺ for ligand binding. Galectins have been implicated in numerous biological roles viz. cell development, apoptosis, cancer, and immune response. While galectins are generally known to bind to type I (Galb3GlcNAc) and type II (Galb4GlcNAc) lactosamine units, their finer substrate specificity and its implications on their numerous biological roles is less understood. The data sets for human galectin-1 and -3 were analyzed using the rule based data mining approach. These two galectins are fundamentally different in terms of organization of their CRDs. Both galectin-1 and -3 share a similar C-terminal F3 type CRD. Galectin-1 is typically a homodimer of CRDs whereas galectin-3 comprises of single CRD with a N-terminus linker domain. The N-terminus domain of galectin-3 has been implicated to enhance its affinity for glycan ligands.

Similar to the above example, the features that enhanced and diminished binding of glycan ligands on the glycan array to galectin-1 and -3 were identified using the rule based data mining approach (Table 3):

TABLE 3
Rules that govern glycan binding to Galectin-1 and -3
The rules are derived based on features [Table 1] where #□ is used to specify number of
occurrences, & implies a combination of rules where each must be satisfied. !□ implies
absence of the pattern. /in the a2/3 and a3/6 to represents a2 or a3 and a3 or a6 respectively.

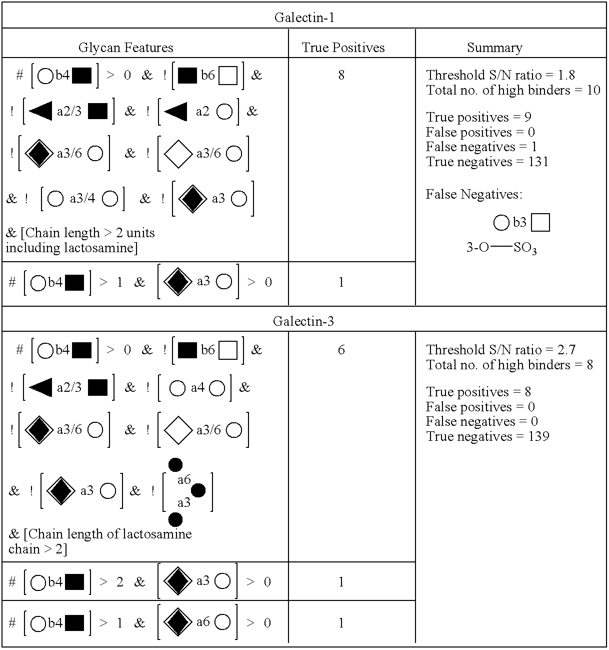

The rules that govern the high affinity ligand binding of galectin-1 and -3 are more complex that those derived for DC-SIGN and -SIGNR. Although it is known that galectins-1 and -3 bind with similar affinity to both type II and type I lactosamine units, the data from the glycan array did not reveal any type I (Galb3GlcNAc) binders based on the threshold intensities that were used to distinguish high binders.

In the case of galectin-1, the first rule (Table 3) that captured 8 out of the 9 high binders included the presence of at least one lactosamine unit in a chain length of at least 3 monosaccharides. Again it is significant to note that there were no false positives. Based on analysis of the low and high affinity binders, several patterns in rule 1 were implicated to have a negative effect on binding. Fucosylation of the GlcNAc, terminal fucosylation of the Gal, sialylation of Gal and also presence of Gala3Gal or Gala4Gal in conjunction with the type II lactosamine unit had negative effects on binding. Furthermore the —Galb4GlcNAcb6GalNAc— unit which comprises of the type II lactosamine on a Core 2 (or Core 4) O-linked core had a negative effect on binding.

The second rule gave an interesting pattern which indicated that sialylation did not have an effect on high affinity binding if the glycan motif comprised of a type II polylactosamine repeat with at least two Galb4GlcNAc units. Earlier studies have implicated that glycans with terminal sialylation are candidate ligands for galectin-1. Since the sialylated glycans used in this study comprised of at least two Galb4GlcNAc units, these results are consistent with our rules. Furthermore, our rules also indicate that galectin-1 binds to internal Galb4GlcNAc units and any other patterns that are farther way in the chain towards non-reducing end have no effect on high affinity binding. There was only one false negative which comprised of Gal[3-O—SO₃]b3GalNAc.

While the rules for galectin-3 binding were similar to galectin-1 there were some differences. These differences are captured in Table 4:

TABLE 4
Comparison of Galectin-1 and Galectin-3 binding

| | Human Galectin-1 | Human Galectin-3 |
|---|---|---|
| 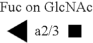 | Inhibits binding | Inhibits Binding |
| 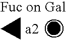 | Inhibits Binding | Does not Inhibit |
| 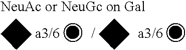 | Inhibits Binding | Inhibits Binding |
| Arrangement of | Prefers Branching | Prefers Linear |
| Lactoseamine units | arrangement | arrangement |
| | over Linear | over Branching |
| | arrangement. | arrangement |
| Minimum Length | Needed | Needed |

The main difference was in the first rule which had a combination of the absence of Mana3(Mana6)Man unit in conjunction with the other patterns. It is important to point out that this rule does not preclude all N-linked glycans. Instead it implies that galectin-3 favors linear repeat of Galb4GlcNAc (polylactosamine) in comparison with Galb4GlcNAc occurring on different branches attached to the Mana3(Mana6)Man of the core. Another difference was that the binding to Galectin-3 was not inhibited by the fucosylation of the Gal in the lactosamine, whereas the binding to Galectin-1 was inhibited by it.

Similar to the DC-SIGN and -SIGNR example, the results from our analysis of the galectin data were compared with structural aspects of ligand binding. Structural complexes of galectin-1 and -3 with different ligands such as Galb4GlcNAc, Neu5Aca3Galb4GlcNAc, Neu5Aca3Galb4(Fuca3)GlcNAc, Neu5Aca6Galb4GlcNAc, etc. were analyzed. The crystal structures of galectin-1 and -3 with Galb4GlcNAc ligands were used respectively as framework to superimpose structures of other ligands and construct the different structural complexes. The 4-, and 6-OH groups of Gal and 3-OH of GlcNAc in the Galb4GlcNAc unit were involved in interactions with the amino acids of the CRD of galectin-1 and -3. Thus, substitution at any of these oxygens resulted in unfavorable steric contacts with the protein.

The rules for galectin binding derived by our approach indicated that Gala4Gal, NeuAca6Gal and Fuca3GlcNAc were detrimental to binding, consistent with the analysis of the structural complexes. The crystal structures also indicated that it is possible to extend Galb4GlcNAc on the non-reducing side with another such unit (via b3 linkage) implying that both galectin-1 and -3 can bind to internal Galb4GlcNAc units. This validates the rule where longer chains having the terminal units such as Galb4(Fuca3)GlcNAc or Neu5Aca3/6Galb4GlcNAc did not have an effect on high affinity binding.

To further validate the rules for binding to Galectin-1 and Galectin-3, the rules were used to predict the relative binding of two different glycans that were not present in the glycan array to Galectin-1 and Galectin-3 (Table 5):

TABLE 5
Prediction of relative binding to Galectin-1 and Galectin-3

| | Human Galectin-1 | | Human Galectin-3 | |
|---|---|---|---|---|
| | Predicted: | Observed: | Predicted: | Observe |
| Glycan | (Relative) | (Relative) | (Relative) | (Relative) |
| 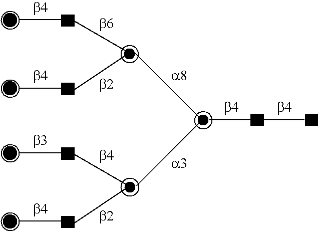 | High | 12.3 | Low | 1 |
| 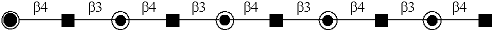 | Low | 1 | High | 3.7 |

As observed earlier, the rules predicted that Galectin-3 favors the linear repeat of lactoseamine, whereas Galectin-1 favors the lactoseamine found in a branched arrangement. This is consistent with the ligand binding propensity that was observed in Hirabayashi et al. (2002).

### Example 4

### Application of Methodology to Hemagglutinin

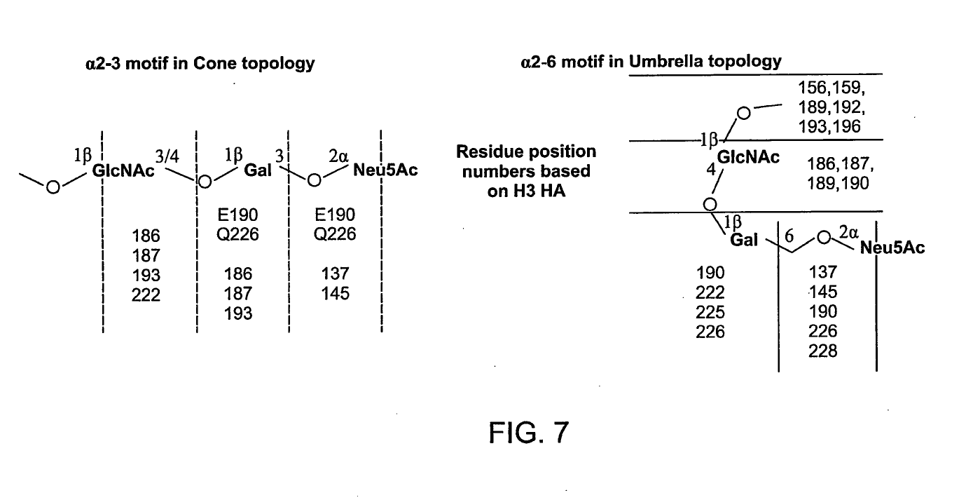

A framework for the binding of H5N1 subtype to α2-3/6 sialylated glycans was developed (FIG. 7). This framework comprises two complementary analyses. The first involves a systematic analysis of an HA glycan binding site and its interactions with α2-3 and α2-6 sialylated glycans using the H1, H3 and H5 HA-glycan co-crystal structures (Table 6).

This analysis provides important insights into the interactions of an HA glycan binding site with a variety of α2-3/6 sialylated glycans, including glycans of either umbrella or cone topology. The second involves a data mining approach to analyze the glycan array data on the different H1, 1-3 and H5 HAs. This data mining analysis correlates the strong, weak and non-binders of the different wild type and mutant HAs to the structural features of the glycans in the microarray (Table 7).

Importantly, these correlations (classifiers) capture the effect of subtle structural variations of the α2-3/6 sialylated linkages and/or of different topologies on binding to the different HAs. The correlations of glycan features obtained from the data mining analysis are mapped onto the HA glycan binding site, providing a framework to systematically investigate the binding of H1, H3 and H5 HAs to α2-3 and α2-6 sialylated glycans, including glycans of different topologies, as discussed below.

To give but one example, application of this framework to H5 HA according to the present invention illustrates how length of an α2-6 oligosaccharide chain becomes more important, especially in the context of degree of branching, than the nuances of structural variations around the glycan. For example, a triantennary structure with a single α2-6 motif versus a biantennary structure with a longer α2-6 motif will influence HA-glycan binding as against structural variations around the individual α2-6 motif. This is confirmed by the distinct length dependent classifiers for the α2-6 motif obtained herein from data mining (Table 7).

### Framework for Binding Specificity of H1, H3 and H5 HAs to α2-3 and α2-6 Sialylated Glycans

Crystal structures of HAs from H1 (PDB IDS: 1RD8, 1RU7, 1RUY, 1RV0, 1RVT, 1RVX, 1RVZ), H3 (PDB IDs: 1MQL, 1MQM, 1MQN) and H5 (1JSN, 1JSO, 2FKO) and their complexes with α2-3 and/or α2-6 sialylated oligosaccharides have provided molecular insights into residues involved in specific HA-glycan interactions. More recently, the glycan receptor specificity of avian and human H1 and H3 subtypes has been elaborated by screening the wild type and mutants on glycan arrays comprising of a variety of α2-3 and α2-6 sialylated glycans.

The Asp190Glu mutation in the HA of the 1918 human pandemic virus reversed its specificity from α2-6 to α2-3 sialylated glycans (Stevens et al., J. Mol. Biol., 355:1143, 2006; Glaser et al., J. Virol., 79:11533, 2005). On the other hand, the double mutation Glu190Asp and Gly225Asp on an avian H1 (A/Duck/Alberta/35/1976) reversed its specificity from α2-3 to α2-6 sialylated glycans. In the case of the H3 subtype, the amino acid changes from Gln226 to Leu and Gly228 to Ser between the 1963 avian H3N8 strain and the 1967-68 pandemic human H3N2 strain correlate with the change in their preference from α2-3 to α2-6 sialylated glycans (Rogers et al., Nature, 304:76, 1983). The relationship between the HA glycan binding specificity and transmission efficiency was demonstrated in a ferret model using the highly pathogenic and virulent 1918 H1N1 viruses (Tumpey, T. M. et al. Science 315: 655, 2007). Switching the receptor binding specificity from the parental human α2,6 sialylated glycan (SC18) receptor preference to an avian α2,3 sialylated receptor preference (AV18) resulted in a virus that was unable to transmit. On the other hand, one of the mixed α-2,3/α-2,6 sialylated glycan specificity virus (A/New York/1/18 (NY18)) showed no transmission, surprisingly A/Texas/36/91 (Tx91) virus, also mixed α2,3/α2,6 sialylated glycan specificity, was able to efficiently transmit. Furthermore, as stated above, various strains of the highly pathogenic H5N1 viruses also show mixed α2,3/α2,6 sialylated glycan specificity (Yamada, S. et al. Nature 444:378, 2006), and have yet been able to transmit from human-to-human. The confounding results with respect to HA's sialylated glycan specificity and transmission posed the following questions. First, is there diversity in the sialylated glycans found in the upper airways in humans, and could that account for the specificity and tissue tropism of the virus? Second, are there nuances of glycan conformation that might play a role in how both α2-3 and/or α2-6 sialylated glycans bind to HA glycan binding pocket? Taken together, what are the glycan binding requirements of the Influenza A virus HA for human adaptation?

### Structural Constraints Imposed by Glycan Topology and Substitutions on H1, H3 and H5 HA Binding to α2-3 Sialylated Glycans

Analysis of all the HA-glycan co-crystal structures indicates that the orientation of the Neu5Ac sugar (SA) is fixed relative to the HA glycan binding site. A highly conserved set of amino acids Phe95, Ser/Thr136, Trp153, His183, Leu/De194 across different HA subtypes are involved in anchoring the SA. Therefore, the specificity of HA to α2-3 or α2-6 is governed by interactions of the HA glycan binding site with the glycosidic oxygen atom and sugars beyond SA.

The conformation of the Neu5Acα2-3 Gal linkage is such that the positioning of Gal and sugars beyond Gal in α2-3 fall in a cone-like region governed by the glycosidic torsion angles at this linkage (FIG. 6). The typical region of minimum energy conformations is given by φ values of around −60 or 60 or 180 where ψ samples −60 to 60 (FIG. 14). In these minimum energy regions, the sugars beyond Gal in α2-3 are projected out of the HA glycan binding site. This is also evident from the co-crystal structures of HA with the α2-3 motif (Neu5Acα2-3Galβ1-3/4GlcNAc—) where the φ value is typically around 180 (referred to as trans conformation). The trans conformation causes the α2-3 motif to project out of the pocket. This implies that structural variations (sulfation and fucosylation) branching at the Gal and/or GlcNAc (or GalNAc) sugars centered on the three sugar (or trisaccharide) α2-3 motif will have the most influence on the HA binding (FIG. 7). This structural implication is consistent with the three distinct classifiers for HA binding to α2-3 sialylated glycans obtained from the data mining analysis (Table 7). The common feature in all these three classes is that the Neu5Acα2-3Gal should not be present along with a GalNAcα/β1-4Gal. Analysis of the crystal structures showed that the GalNAc linked to Gal of Neu5Acα2-3Gal made unfavorable steric contacts with the protein, consistent with the classifiers.

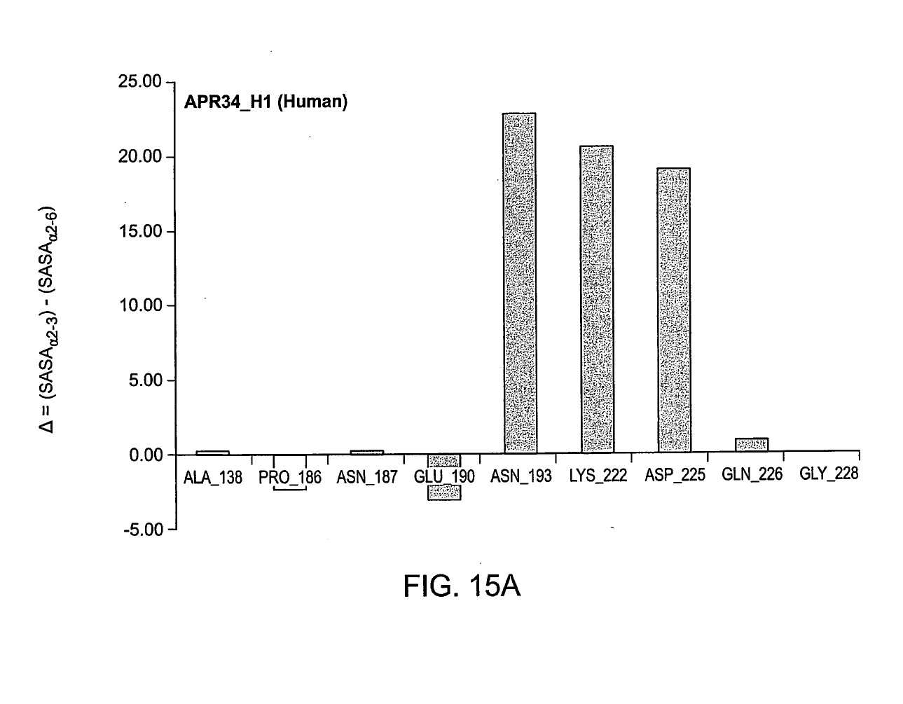

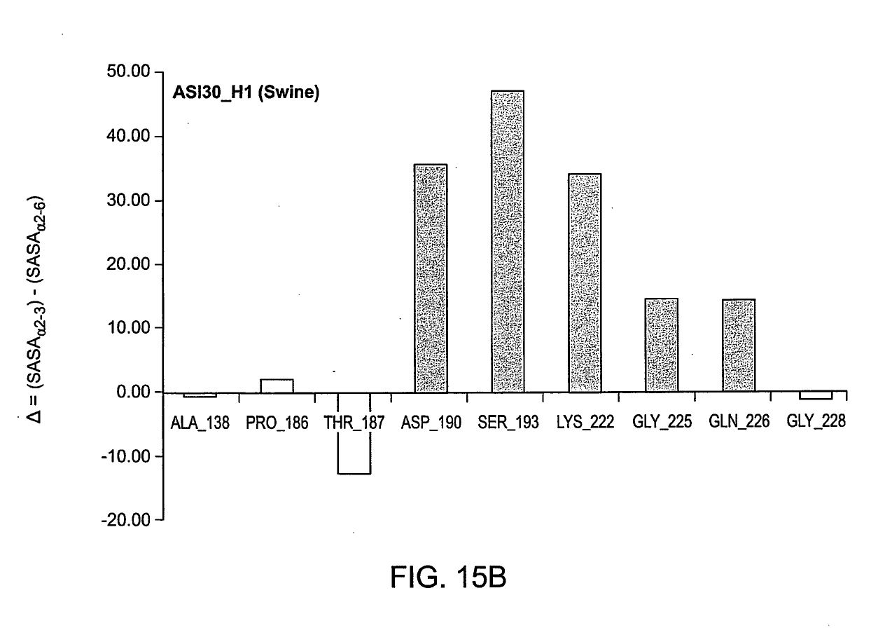

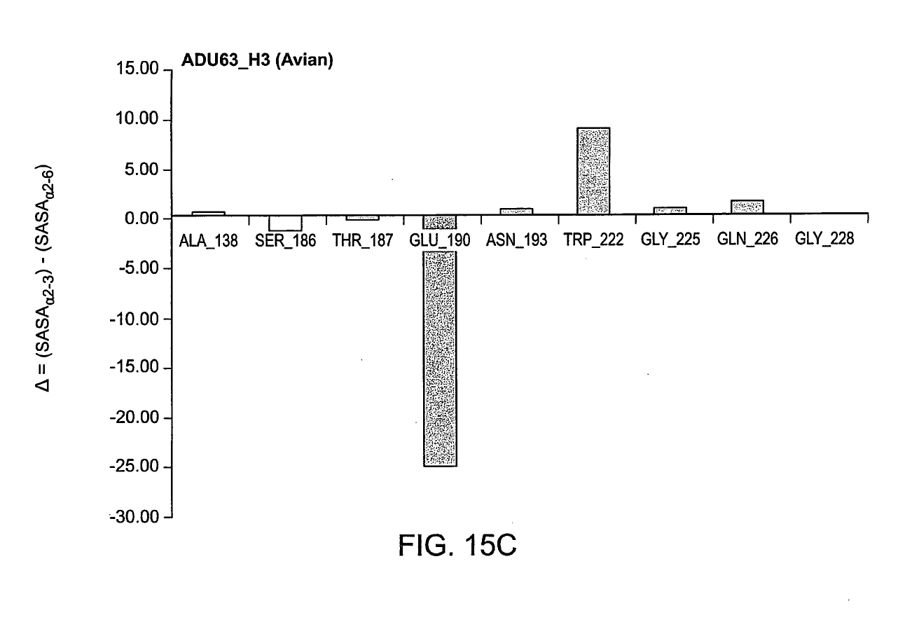

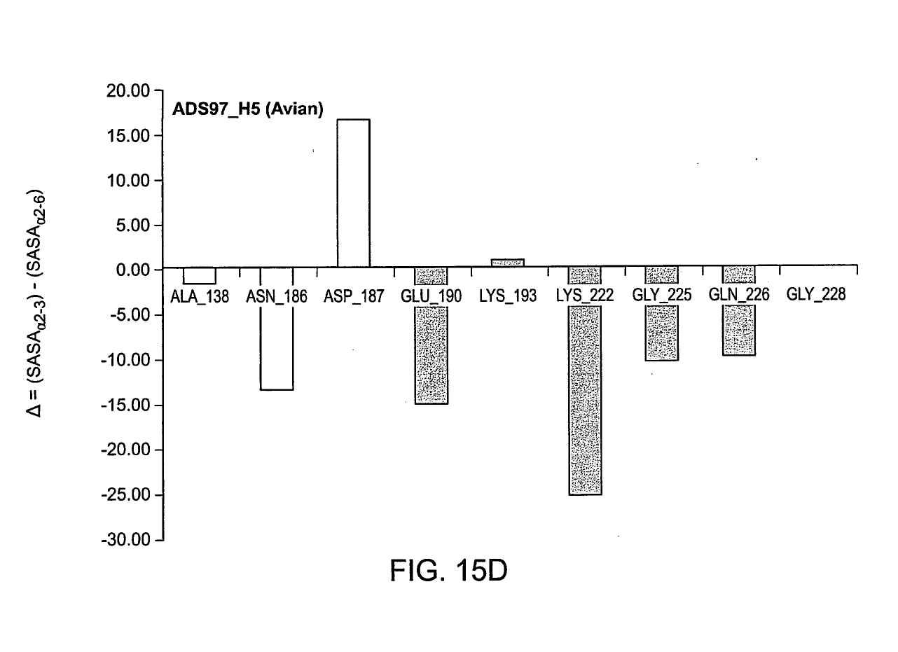

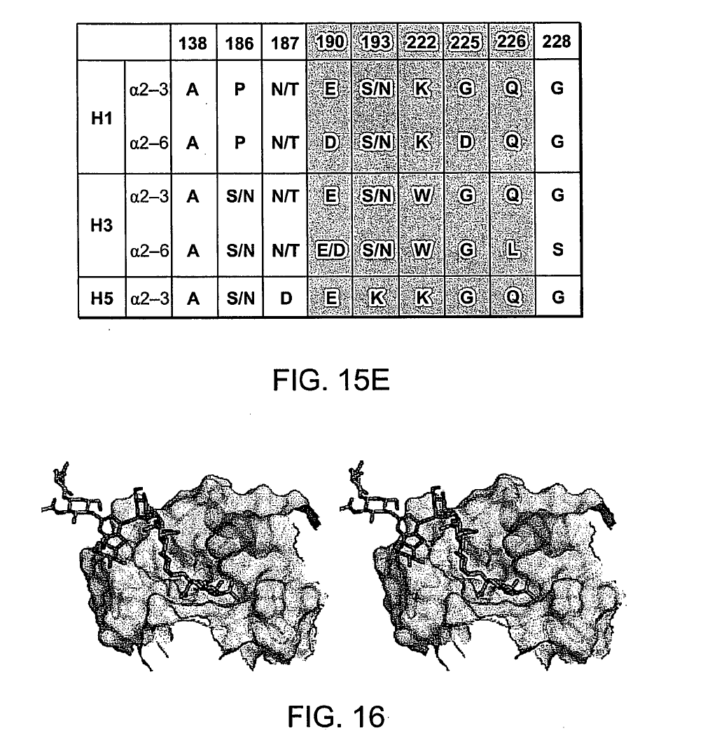

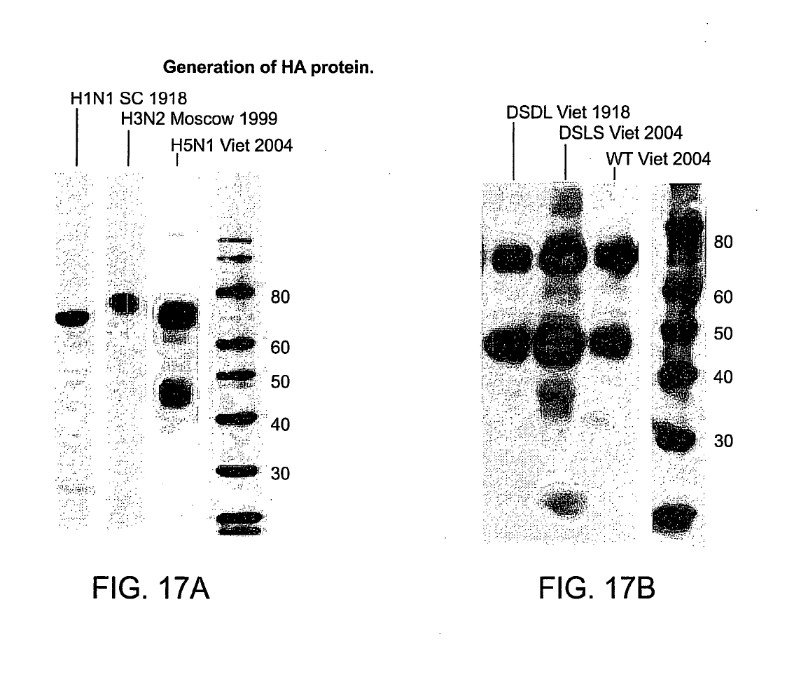

In addition to the conserved anchor points for sialic acid binding, two critical residues, Gln226 and Glu190, are involved in binding to the Neu5Acα2-3Gal motif. Gln226, located at the base of the binding site, interacts with the glycosidic oxygen atom of the Neu5Acα2-3Gal linkage (FIG. 15, Panels C,D). Glu190, located on the opposite side of Gln226 interacts with Neu5Ac and Gal monosaccharides (FIG. 15, Panels C,D). Further, residues Ala138 (proximal to Gln226) and Gly228 (proximal to Glu190), which are highly conserved in avian HAs could be involved in facilitating the right conformation of Gln226 and Glu190 for optimal interactions with α2-3 sialylated glycans (FIG. 15). APR34, a human H1 subtype, contains all the four amino acids Ala138, Glu190, Gln226 and Gly228 and binds to α2-3 sialylated glycans as observed in its crystal structure (FIG. 14, Panel B).

Superimposition of the glycan binding site in the crystal structures of AAI68_H3_{—}23, ADU67_H3_{—}23 and APR34_H1_{—}23 gives additional insights into the positioning of the Glu190 side chain and its effect on HA binding to α2-3 sialylated glycans. The side chain of Glu190 in H1 HA is further (around 1 Å) into the binding site in comparison with that of Glu190 in 1-13 HA. This could be due to the amino acid differences Pro186 in H1 HA as against Ser186 in H3 HA which are proximal to the Glu190 residue. This change in side chain conformation of Glu190 could correlate with the binding of avian H1 (and not avian H3) with moderate affinity to some of the α2-6 sialylated glycans as shown by the data mining analysis of the glycan microarray data (Table 7). Further, substitution of Gly228 to Ser—a hallmark change between avian and human H3 subtypes—alters the conformation of Glu190 and interferes with the interaction of human H3 HA to Neu5Acα2-3Gal in the trans conformation: This is further elaborated by the distinct conformation (that is not trans) of Neu5Acα2-3Gal motif observed in the human AAI68_H3_{—}23 co-crystal structure. The Neu5Acα2-3Gal motif in this conformation provides less optimal contacts with human H3 HA binding site compared to those provided by this motif in the trans conformation with the avian H3 HA (FIG. 14). As a consequence of this loss of contacts, the Gly228Ser mutation in human H3 HA makes its glycan binding site less favorable for interaction with α2-3 sialylated glycans. This structural observation is consistent with the results from the data mining analysis (Table 7) which shows that the human H3 HA has only a moderate affinity for some of the α2-3 sialylated glycans.

How do the structural variations around the Neu5Acα2-3Gal influence HA-glycan interactions? Lys193, which is highly conserved in the avian H5 (FIG. 5) is positioned to interact with 6-O sulfated Gal and/or 6-O sulfated GlcNAc in Neu5Acα2-3Galβ1-4GlcNAc. This observation is validated by the data mining analysis wherein only the avian H5 binds with high affinity to α2-3 sialylated glycans that are sulfated at the Gal or GlcNAc (Table 7). In a similar fashion, a basic amino acid at position 222 could interact with 4-O sulfated GlcNAc in Neu5Acα2-3Galβ1-3GlcNAc motif or 6-0 sulfated GlcNAc in Neu5Acα2-3Galβ1-4GlcNAc motif. On the other hand, a bulky side chain such as Lys222 in H1 and H5 and Trp222 in H3 potentially interferes with a fucosylated GlcNAc in Neu5Acα2-3Galβ1-4(Fucα1-3) GlcNAc motif. This structural observation corroborates the classifier rule α2-3 Type C observed for avian H3 and H5 strains (Table 7), which shows that fucosylation at the GlcNAc is detrimental to binding. The binding of Viet04_H5 HA to α2-3 sialylated glycans is similar to that of ADS97_H5 HA (Table 7) given the almost identical amino acids in their respective glycan binding sites.

Thus, for binding to α2-3 sialylated glycans, apart from the residues that anchor Neu5Ac, Glu190 and Gln226, highly conserved in all avian H1, H3 and H5 subtypes are critical for binding to Neu5Acα2-3Gal motif. The contacts with GlcNAc or GalNAc and substitutions such as sulfation and fucosylation in the α2-3 motif involve amino acids at positions 137, 186, 187, 193 and 222. HA from H1, H3 and H5 exhibit differential binding specificity to the diverse α2-3 sialylated glycans present in the glycan microarray. The amino acid residues in these positions are not conserved across the different HAs and this accounts for the different binding specificities

### Structural Constraints Imposed by Glycan Topology and Substitutions on H1 and H3 HA Binding to α2-6 Sialylated Glycans

In the case of Neu5Aca2-6 Gal linkage, the presence of the additional C6-C5 bond provides added conformational flexibility. The position of Gal and subsequent sugars in α2-6 would span a much larger umbrella-like region as compared to the cone-like region in the case of α2-3 (FIG. 6). The binding to α2-6 would involve optimal contacts with the Neu5Ac and Gal sugars at the base of such an umbrella topology and also the subsequent sugars depending on the length of the oligosaccharide. Short α2-6 oligosaccharides such as Neu5Acα2-6 Galβ1-3/4Glc would potentially adopt a cone-like topology. On the other hand, the presence of a GlcNAc instead of Glc in the α2-6 motif Neu5Acα2-6Galβ1-4GlcNAc— would potentially favor the umbrella topology which is stabilized by optimal van der Waals contact between the acetyl carbons of both GlcNAc and Neu5Ac. However, the α2-6 motif can also adopt a cone topology such that additional factors such as branching and HA binding can compensate for the stability provided by the umbrella topology. The cone topology of the α2-6 motif present as a part of multiple short oligosaccharide branches in an N-linked glycan could be stabilized by intra sugar interactions. On the other hand, the umbrella topology would be favored by the α2-6 motif in a long oligosaccharide branch (at least a tetrasaccharide). The co-crystal structures of H1 and H3 HAs with the α2-6 motif (Neu5Acα2-6Galβ1-4GlcNAc—) motif supports the above notion wherein the φ˜−60 (referred to as cis conformation) causes the sugars beyond Neu5Acα2-6Gal to bend towards the HA protein to make optimal contacts with the binding site (FIG. 7).

In H1 HA, superimposition of the glycan binding domain of HA from a human H1N1 (A/South Carolina/1/1918) subtype with that of ASI30_H1_{—}26 and APR34_H1_{—}26 provided insights into the amino acids involved in providing specificity to the α2-6 sialylated glycan. Lys222 and Asp225 are positioned to interact with the oxygen atoms of the Gal in the Neu5Acα2-6Gal motif. Asp190 and Ser/Asn193 are positioned to interact with additional monosaccharides GlcNAcα1-3Gal of the Neu5Acα2-6Galα1-4GlcNAcα1-3Gal motif (FIG. 15, Panels A,B).

Asp190, Lys222 and Asp225 are highly conserved among the H1 HAs from the 1918 human pandemic strains. Although the amino acid Gln226 is highly conserved in all the avian and human H1 subtypes, it does not appear to be as involved in binding to α2-6 sialylated glycans (in human H1 subtypes) compared to its role in binding to α2-3 sialylated glycans (in the avian H1 subtypes). The data mining analysis of the glycan array results for wild type and mutant form of the avian and human H1 HAs further substantiates the role of the above amino acids in binding to α2-6 sialylated glycans (Table 7). The Glu190Asp/Gly225Asp double mutant of the avian H1 HA reverses its binding to α2-6 sialylated glycans (Table 7). Further, the Lys222Leu mutant of human ANY18_H1 removes its binding to all the sialylated glycans on the array consistent with the essential role of Lys222 in glycan binding.

In order to identify amino acids that provide specificity for H3N2 HA binding to α2-6 sialylated glycans, the glycan binding domain of HA from human H3N2 (AAI68_H3), ADU63_H3_{—}26 and ASI30_H1_{—}26 were superimposed. Analysis of these superimposed structures showed that Leu226 is positioned to provide optimal van der Waals contact with the C6 atom of the Neu5α2-6 Gal motif and Ser228 is positioned to interact with O9 of the sialic acid. Ser228 in the human H3 also interacts with Glu190 (unlike Gly228 in avian ADU63_H3 which does not) thereby affecting its side chain conformation. The side chain of Glu190 in human H3 HA is displaced slightly into the binding site by about 0.7 Å in comparison with that of Glu190 in avian H3 HA. These differences limit the ability of human H3 HA to bind to α2-3 sialylated glycans and correlate with its preferential binding to α2-6 sialylated glycans. Thus, the Gln226Leu and Gly228Ser mutations cause a reversal of the glycan receptor specificity of avian H3 to human H3 subtype during the 1967 pandemic.

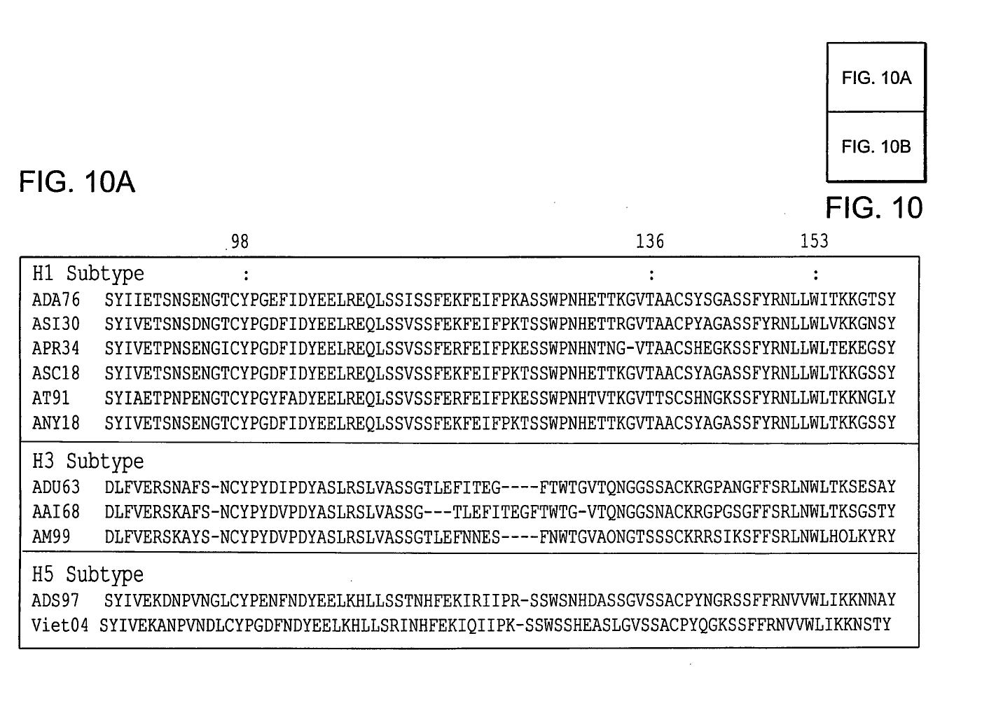

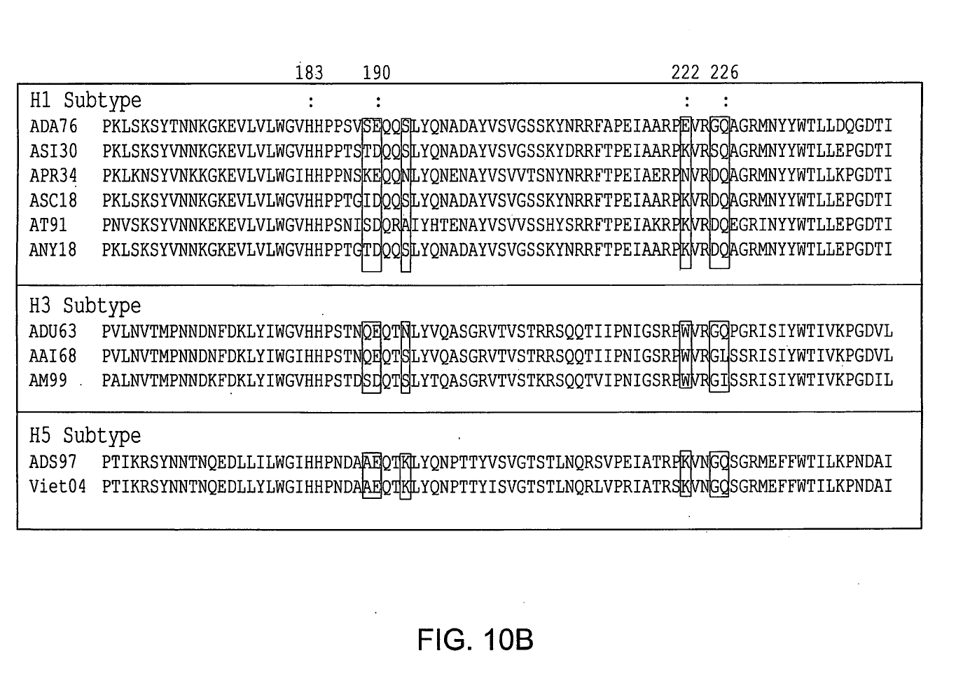

Comparison of HAs from 1967-68 pandemic H3N2 and those from more recent H3 subtypes (after 1990) show that the Glu190 is mutated to Asp in the recent subtypes. This mutation further enhances the binding of human H3 to α2-6 sialylated glycans since Asp190 in human H3 is positioned to interact favorably with these glycans. This structural implication is further corroborated by the data mining analysis of the glycan array data on a human H3 subtype (A/Moscow/10/1999). This HA comprises Asp190, Leu226 and Ser228 (FIG. 10) and shows strong preference to α2-6 sialylated glycans (Table 7).

The above observations highlight both the similarities as well as differences between H1 and H3 HA binding to α2-6 sialylated glycans. In both H1 and H3 HA, Asp190 and Ser/Asn193 are positioned to make favorable contacts with monosaccharides beyond Neu5Acα2-6Gal motif (FIG. 15, Panels A,B). The differences in the amino acids and their contacts with α2-6 sialylated glycans between H1 and H3 HA provide distinct surface and ionic complementarity for binding these glycans. The Neu5Acα2-6Gal linkage has an additional degree of conformational freedom than the Neu5Acα2-3Gal. Thus the HA binding to α2-6 sialylated glycans has a more open binding pocket to accommodate this conformational freedom. While Leu226 in human H3 HA is positioned to provide optimal van der Waals contact with Neu5Acα2-6Gal, the ionic contacts provided by Gln226 in H1 HA to this motif are not as optimal. On the other hand in H1, the amino acids Lys222 and Asp225 provide more optimal ionic contacts with α2-6 sialylated glycans compared to Trp222 and Gly225 in H3.

### Structural Constraints for Binding of Wild Type and Mutant H5 HAs to α2-6 Sialylated Glycans

The interactions with α2-6 sialylated glycans provided by the different amino acids in H1 and H3 HA suggested that the current avian H5N1 HA could mutate into a H1-like or H3-like glycan binding site in order to reverse its glycan receptor specificity. Based on the above framework, the hypothesized H1-like and H3-like mutations for H5 HA are further elaborated and tested as discussed below.

Analysis of the superimposed ASI30_H1_{—}26, APR34_H1_{—}26, ADS97_H5_{—}26 and Viet04_H-5 structures provided insights into the H1-like binding of H5 HA to α2-6 sialylated glycans. Since the H1 and H5 HAs belong to the same structural clade, their glycan binding sites share a similar topology and distribution of amino acids (Russell et al., Virology, 325:287, 2004). Lys222, which is highly conserved in avian H5 HAs is positioned to provide optimal contacts with Gal of Neu5Acα2-6Gal motif similar to the analogous Lys in H1 HA. Glu190 and Gly225 in Viet04_H5 (in the place of Asp190 and Asp225 in H1) do not provide the necessary contacts with the Neu5Acα2-6Galβ1-4GlcNAc motif similar to H1. Therefore Glu190Asp and Gly225Asp mutations in H5 HA could potentially improve the contacts with α2-6 sialylated glycans.

Analysis of the interactions beyond GlcNAc in the Neu5Acα2-6Galβ1-4GlcNAcβ1-3Galβ1-4Glc oligosaccharide and the glycan binding pocket of H1 and H5 HAs showed that while Ser/Asn193 in H1 HA provides favorable contacts with the penultimate Gal, the analogous Lys193 in H5 has unfavorable steric overlaps with the GlcNAcβ1-3Gal motif. Thus, the Lys193Ser mutation can provide additional favorable contacts (along with Glu190Asp and Gly225Asp mutations) with α2-6 sialylated glycans.

The highly conserved Gln226 in H1 HA is also conserved in the avian H5 HA. Given that Gln226 plays a less active role in H1 HA binding to α2-6 sialylated glycans (as discussed above), mutation of this amino acid to a hydrophobic amino acid such as Leu could potentially enhance its van der Waals contact with C6 atom of Gal in Neu5Acα2-6Gal motif.

The superimposition of ADU63_H3_{—}26, AAI68_H3, ADS97_H5_{—}26 and Viet04_H5 provides insights into the H3-like binding of H5 HA to α2-6 sialylated glycans. While this superimposition structurally aligned the glycan binding site of H5 and H3 HA, it was not as good as the structural alignment between H5 and H1. The favorable van der Waals contact and ionic contact with Neu5α2-6Gal motif respectively provided by Leu226 and Ser228 in H3 HA were absent in H5 HA (with Gln226 and Gly228). Given that Leu226 and Ser228 are critical for binding to α2-6 sialylated glycans in human H3 HA, the Gln226Leu and Gly228Ser mutations in H5 HA could potentially provide optimal contacts with α2-6 sialylated glycans. Further, even in the comparison between H3 and H5, Lys193 is positioned such that it would have unfavorable steric contacts with the monosaccharides beyond Neu5Acα2-6Gal motif as against Ser193 in human H3 HA which is positioned to provide favorable contacts. Although the HA from the 1967-68 pandemic H3N2 comprises of Glu190, Asp190 in H5 HA would be positioned to provide better ionic contacts with Neu5Acα2-6Gal motif in longer oligosaccharides.

The roles of the above mentioned residues were further corroborated by data mining analysis of glycan array data for wild type and mutant forms of Viet04_H5 (Table 7). The double mutant, Glu190Asp/Gly225Asp, does not bind to any glycan structure since it loses the amino acid Glu190 for binding α2-3 sialylated glycans and has the steric interference from Lys193 for binding to α2-6 sialylated glycans. Similarly the double mutant, Gln226Leu/Gly228Ser binds to some of the α2-3 sialylated glycans (α2-3 Type B classifier) but only to a single biantennary α2-6 sialylated glycan (α2-6 Type A classifier).

Analysis of this binding to the biantennary α2-6 sialylated glycan showed that the Neu5Acα2-6Gal linkage in this glycan can potentially bind in an extended conformation to the double mutant albeit with lesser contacts (FIG. 16). Furthermore, the Neu5Acα2-6Gal on the Malα1-3Man branch binds more favorably compared to the same motif on the Manα1-6Man branch which has unfavorable steric contacts with the glycan binding site of H5 HA (FIG. 16). The narrow specificity of the Gln226Leu/Gly228Ser double mutant to α2-6 sialylated glycans is consistent with Lys193 interfering with the binding.

Without wishing to be bound by any particular theory, the present inventors propose that a necessary condition for human adaptation of influenza A virus HAs is to gain the ability to bind to long α2-6 (predominantly expressed in human upper airway) with high affinity. For example, an aspect of glycan diversity is the length of the lactosamine branch that is capped with the sialic acid. This is captured by the two distinct features of α2-6 sialylated glycans derived from the data mining analysis (Table 7). One feature is characterized by the Neu5Acα2-6 Galβ1-4GlcNAc linked to the Man of the N-linked core and the other is characterized by this motif linked to another lactose amine unit forming a longer branch (which typically adopts umbrella topology). Thus, the extensive binding of the mutant H5 HAs to the upper airways may only be possible if these mutants bind with high affinity to the glycans with long α2-6 adopting the umbrella topology. For example, according to the present invention, desirable binding patterns include binding to umbrella glycans depicted in FIG. 9.

By contrast, we note a recent report of modified H5 HA proteins (containing Gly228Ser and Gln226Leu/Gly228Ser substitution) showed binding to only a single biantennary α2-6 sualyl-lactosamine glycan structure on the glycan array (Stevens et al., Science 312:404, 2006). Such modified H5 HA proteins are therefore not BSHB H5 HAs, as described herein.

### Binding of Wild Type and Mutant H5 HAs to α2-6 Sialylated Glycans

Thus, the present invention demonstrates that the current avian H5N1 HA, can undergo mutations that would alter its specificity towards α2-6 glycans based on interactions of human H1 or H3 HA with these glycans. The Glu190Asp, Lys193Ser, Gly225Asp and Gln226Leu mutations (“DSDL mutant”) could potentially make the 1-15 HA binding site similar to that of the human H1 HA, while the Glu190Asp, Lys193Ser, Gln226Leu and Gly228Ser (“DSLS mutant”) could potentially make it similar to that of the human H3 HA for optimal interactions with α2-6 sialylated glycans. DSDL and DSLS H5 HA mutants were designed and tested based on the above framework. Wild type and mutant BSHB H5 HAs were expressed in baculovirus and purified as reported earlier (FIG. 10XXXY).

We found that only recombinant wild type H5 HA bound extensively to the alveolar region, and very little if any to the trachea or bronchus consistent with binding of avian H5 HA to α2-3 sialylated glycans. In contrast, only the DSLS mutant (H3-like) binds to the upper airway tracheal and bronchial tissues; and further this mutant does not bind to the deep lung alveolar tissues.

For the tissue binding experiment, tissue sections were deparaffinized, rehydrated and incubated with the WT and the mutant HA proteins (diluted in PBS) for 3 hr. Based on the protein concentration for a given lot after purification, appropriate serial dilutions in the ranges of 1:10-1:100 were tested. After extensive washing with PBS, the sections were blocked with 2% BSA-PBS for 30 min and then incubated with rabbit anti avian H5N1 hemagglutinin antibody (Pro-Sci Inc, 1:1000 in 2% BSA-PBS) for 3 hr. Sections were Washed with PBS and then incubated with secondary goat-anti rabbit antibody (Invitrogen; 1:500 in 2% BSA-PBS) for 90 min. Sections were counterstained with propidium iodide (in red; Invitrogen; 1:200 in PBS) and then viewed under a confocal microscope (Zeiss LSM510 laser scanning confocal microscopy). All incubations were at room temperature.

The observation that the DSLS version of H5 HA, but not the DSDL version, bound to tracheal and bronchial sections (but not to alveolar) was intriguing given that both DSDL and DSLS mutants were expected to bind extensively to α2-6 sialylated glycans in the upper airway based on our framework. The Ser193 instead of Lys193 in both these mutants would have removed the steric hindrance imposed by Lys193 (in the wild type H5 HA) to provide them with broad specificity towards α2-6 sialylated glycans. Further, given that H5 and H1 belong to the same structural clade, it would be been more likely for H5 HA to mutate into a H1-like glycan binding site.

To further understand the inability of DSDL mutant to bind to α2-6 sialylated glycans, this mutation was mapped on to the Viet04_H5 crystal structure which was further superimposed with ASI30_H1_{—}26 and APR34_H1_{—}26 crystal structures. This mapping showed that all the contacts with the α2-6 sialylated oligosaccharide are conserved between H1 HAs and the DSDL mutant. However, Asp187, which is highly conserved in avian H5 HA was in close proximity to the Asp190 in the DSDL mutant. The presence of 3 aspartates (Asp187, Asp190 and Asp225) further explained the pI of 6.8 for the DSDL mutant (as compared to 7.3 for WT and DSLS mutant). The interaction between Asp187 and Asp190 could potentially alter conformation of Asp190 similar to the influence of Ser228 on Glu190 in H3 HA. The effect of proximity of amino acid at 187 on Asp190 is also evident from the differences in SASA of Thr187 in ASI30_H1 interacting with α2-3 vs. α2-6 sialylated glycan. Given that Asp190 is involved in forming optimal contacts with α2-6 sialylated glycans in H1 HA, the effect of Asp187 on Asp190 could potentially disrupt this interaction. Perhaps the mutation of highly conserved Gln226 in H1 HA to Leu in the DSDL mutant could have affected the environment of HA binding site of this mutant in the context of the other H1-like mutations and made it less optimal for binding to α2-6 sialylated glycans.

The role of Gln226 in the H1-like binding of H5 HA was further tested using a Glu190Asp/Lys193Ser or DS mutant which retains the Gln226. The lack of binding of the DS mutant to the deep lung tissues is consistent with the loss of binding to α2-3 sialylated glycans (due to Glu190Asp mutation). Similarly the lack of binding of this mutant to the upper airway tissues further supports the disruptive effect of Asp187 on Asp190 which could lower the binding of this mutant to α2-6 sialylated glycans. Thus, the mutations in current avian H5N1 HA would prefer leading to a H3-like (as compared to an H1-like) glycan binding site having a broad specificity for α2-6 sialylated glycans.

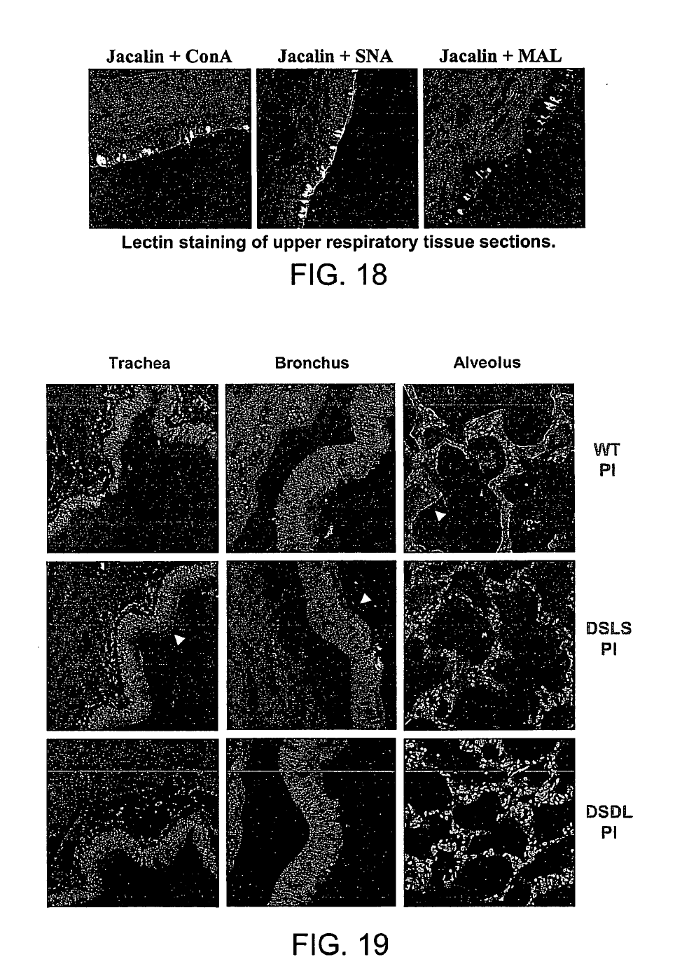

The binding of the DSLS mutant to the upper lung raises the question as to the diversity of the α2-6 sialylated glycans in the upper airways. Lectin staining of the human bronchial epithelial (HBE) cells clearly shows that these cells are abundant in different α2-6 sialylated glycans such as N-linked, O-linked and glycolipids (FIG. 18). The diversity of these α2-6 sialylated glycans is further elaborated by the isolation of N-linked glycans from the cell surface of HBE cells and their characterization using MALDI-MS analysis.

Specifically, about 70×10⁶16HBE14o-cells (a gift from Dr. D. C. Gruenert; University of California, San Francisco) were harvested when they were >90% confluent with 100 mM citrate saline buffer and the cell membrane was isolated after treatment with protease inhibitor (Calbiochem) and homogenization. The cell membrane fraction was treated with PNGaseF (New England Biolabs) and the reaction mixture was incubated overnight at 37° C. The reaction mixture was boiled for 10 min to deactivate the enzyme and the deglycosylated peptides and proteins were removed using a Sep-Pak C18 SPE cartridge (Waters). The glycans were further desalted and purified into neutral (25% acetonitrile fraction) and acidic (50% acetonitrile containing 0.05% trifluoroacetic acid) fractions using graphitized carbon solid-phase extraction columns (Supelco). The acidic fractions (containing sialylated glycans) were analyzed by MALDI-TOF MS in negative ion mode with soft ionization conditions (accelerating voltage 22 kV, grid voltage 93%, guide wire 0.3% and extraction delay time of 150 ns). This MALDI TOF-TOF fragmentation analysis of representative mass peaks illustrated the diversity in terms of branching pattern and increased branch length in the N-linked glycans. The longer branch length versus higher branching observed in the glycan profile can influence the binding of H5 HA to these glycans.

For example, an aspect of glycan diversity is the length of the lactosamine branch that is capped with the sialic acid. This is captured by the two distinct features of α2-6 sialylated glycans derived from the data mining analysis (Table 7). One feature is characterized by the Neu5Acα2-6Galβ1-4GlcNAc linked to the Man of the N-linked core and the other is characterized by this motif linked to another lactose amine unit forming a longer branch. Thus, the extensive binding of the mutant H5 HAs to the upper airways is only possible if these mutants have a broad binding specificity to α2-6 sialylated glycans. For example, according to the present invention, desirable binding patterns include those depicted in FIG. 9 and/or:

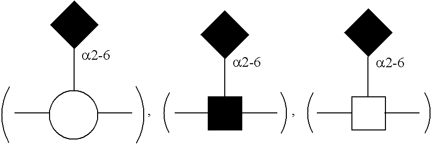

and combinations thereof:

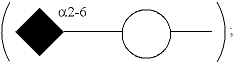

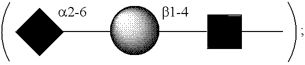

and/or

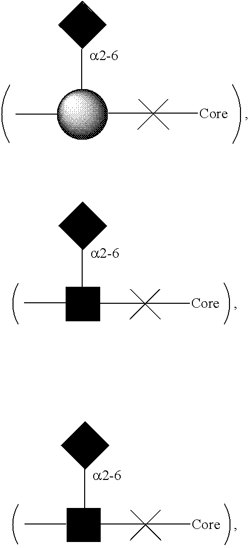

and combinations thereof.

By contrast, we note a recent report of modified H5 HA proteins (containing Gly228Ser and Gln226Leu/Gly228Ser substitution) showed binding to only a single biantennary α2-6 sualyl-lactosamine glycan structure on the glycan array (Stevens et al., Science 312:404, 2006). Such modified H5 HA proteins are therefore not BSHB H5 HAs, as described herein.

### EQUIVALENTS

Those skilled in the art will recognize, or be able to ascertain using no more than routine experimentation, many equivalents to the specific embodiments of the invention described herein. The scope of the present invention is not intended to be limited to the above Description, but rather is as set forth in the following claims:

TABLE 6
Crystal structures of HA-glycan complexes

| Abbreviation (PDB ID) | Virus strain | Glycan (with assigned coordinates) |
|---|---|---|
| ASI30_H1_23 (1RV0) | A/Swine/Iowa/30 (H1N1) | Neu5Ac |
| ASI30_H1_26 (1RVT) | A/Swine/Iowa/30 (H1N1) | Neu5Acα6Galβ4GlcNAcβ3Galβ4Glc |
| APR34_H1_23 (1RVX) | A/Puerto Rico/8/34 (H1N1) | Neu5Acα3Galβ4GlcNAc |
| APR34_H1_26 (1RVZ) | A/Puerto Rico/8/34 (H1N1) | Neu5Acα6Galβ4GlcNAc |
| ADU63_H3_23 (1MQM) | A/Duck/Ukraine/1/63 (H3N8) | Neu5Acα3Gal |
| ADU63_H3_26 (1MQN) | A/Duck/Ukraine/1/63 (H3N8) | Neu5Acα6Gal |
| AAI68_H3_23 (1HGG) | A/Aichi/2/68 (H3N2) | Neu5Acα3Galβ4Glc |
| ADS97_H5_23 (1JSN) | A/Duck/Singapore/3/97 (H5N3) | Neu5Acα3Galβ3GlcNAc |
| ADS97_H5_26 (1JSO) | A/Duck/Singapore/3/97 (H5N3) | Neu5Ac |
| Viet04_H5 (2FK0) | A/Vietnam/1203/2004 (H5N1) | |

The HA-α2-6 sialylated glycan complexes were generated by superimposition of the CA trace of the HA1 subunit of ADU63_H3 and ADS97_H5 and Viet04_H5 on ASI30_H1_26 and APR34_H1_26 (H1). Although the structural complexes of the human A/Aichi/2/68 (H3N2) with α2-6 sialylated glycans are published¹⁷, their coordinates were not available in the Protein Data Bank. The SARF2 (http://123d.ncifcrf.gov/sarf2.html) program was used to obtain the structural alignment of the different HA1 subunits for superimposition.

TABLE 7
Glycan receptor specificity of HAs based on classifier rules

| Influenza Strain | α2-3 Type^{a} | α2-6 Type^{b} |
|---|---|---|
| A/Duck/Alberta/35/76 (Avian H1N1) | 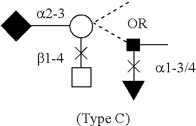 | 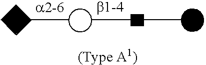 |
| A/Duck/Alberta/35/76 (Avian H1N1) Glu190Asp/Gly225 Asp double mutant | No | 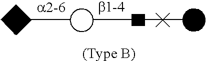 |
| A/South Carolina/1/18 (Human H1N1) | No | 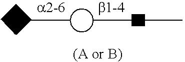 |
| A/New York/1/18 (Human H1N1) | 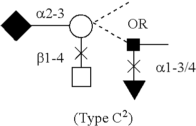 | 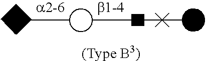 |
| A/Texas/36/91 (Human H1N1) | 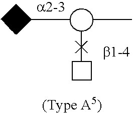 | 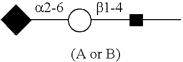 |
| A/NewYork/1/18 (Human H1N1) Asp 190Glu mutant⁴ | 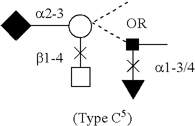 | 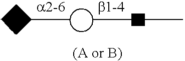 |
| A/New York/1/18 (Human H1N1) Lys222 Leu mutant | No | No |
| A/Duck/Ukraine/1/63 (Avian H3N8) | 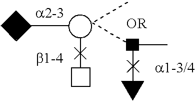 | No |
| A/Moscow/10/99 (Human H3N2) | No⁶ | 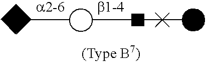 |
| A/Duck/Singapore/3/97 (Avian H5N3) | 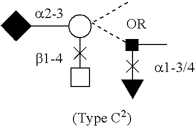 | No |
| A/Vietnam/1203/04 (Avian H5N1) | 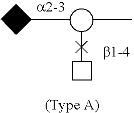 | No |
| A/Vietnam/1203/04 (Avian H5N1) Glu 190Asp/Gly225 Asp double mutant | No | No |
| A/Vietnam/1203/04 (Avian H5N1) Gln226Leu/Gly228Ser double mutant | 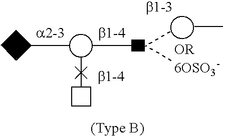 | 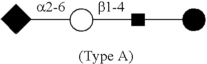 |
| A/Vietnam/1203/04 (Avian H5N1) Arg216Glu, Ser221 Pro double mutant | 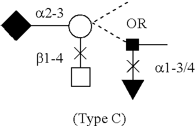 | No |

¹Border line high binder;
²Sulfated GlcNAc[6/S]/Gal[6S] high binders
³Border line high) binders to a2-6 Type B. Only sulfated GlcNAc[6S]/Gal[6S] are high binders;
⁴Binds to several non-sialylated glycans;
⁵Border line high to α2-3 sialylated glycans;
⁶Few border line high binders to sulfated GlcNAc on Neu5Acα3Galβ3/4GlcNAc;
⁷High binders are Neu5Acα6Galβ4GlcNAcβ3Gal & !GlcNAcα6Man; Others are borderline high.
Keys:

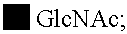

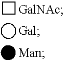

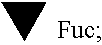

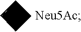

The data from glycan microarray screening of H1, H3 and H5 subtypes were obtained from the
Consortium for Functional Glycomics (CFG) web site-
http://www.functionalglycomics.org/glycomics/publicdata/primaryscreen.jsp.
The details of the data mining analysis including the description of features and
classifiers are provided in Suppl Fig. 5. The rule induction classification method was used
to generate the following classifiers (or rules) that govern the binding of HA to
α2-3/6 sialylated glycans. Classifiers for α2-3 sialylated glycan binding- Type A:
Neu5Acα3Gal & !GalNAcβ4Gal, Type B: Neu5Acα3Galβ4GlcNAc & !GalNAcβ4Gal &
{GlcNAcβ3Gal or GlcNAc[6S]}, Type C: Neu5Acα3Galβ &
!GalNAcβ4Gal & !Fucα3/4GlcNAc. Classifiers for α2-6 sialylated glycan binding- Type A:
Neu5Acα6Galβ4GlcNAcb?Man, Type B: Neu5Acα6Galβ4GlcNAc & !GlcNAcb?Man.
These complex rules are graphically represented in the table for clarity.
The rules are provided as a logical combination of features among high affinity
binders that enhance binding and features among weak and non-binders that are
detrimental to binding (shown after the ‘!’ symbol in the text description and as a red
linkage with a ’x' sign in the graphical representation). The presence of mannose in the α2-6
classifiers arises from the single 6′-sialyl lactosamine containing biantennary N-linked glycan
on the glycan array.

We claim:

1. A method comprising steps of:
determining features of glycan structure;
correlating binding of a glycan binding protein to a plurality of glycans with the determined features present in the glycans.

2. The method of claim 1, wherein the step of correlating comprises comparing binding data of the glycan binding protein binding to a plurality of glycans containing the features, and correlating degree of binding with presence or absence of feature.

3. The method of claim 1 or claim 2, wherein the features are selected from the group consisting of monosaccharide-level features, higher order features, GBP binding features, and combinations thereof.

4. The method of claim 3, wherein the monosaccharide-level features are selected from the group consisting of composition, explicit composition, and combinations thereof.

5. The method of claim 3, wherein the monosaccharide-level features include terminal composition.

6. The method of claim 3, wherein the higher order features are selected from the group consisting of pairs, triplets, quadruplets, clusters, average leaf depth, number of leaves, and combinations thereof.

7. The method of claim 6, wherein the pairs are selected from the group consisting of regular pairs, terminal pairs, and combinations thereof.

8. The method of claim 6, wherein the triplets are selected from the group consisting of regular, terminal, surface, and combinations thereof.

9. The method of claim 6, wherein the quadruplets are selected from the group consisting of regular, terminal, surface, and combinations thereof.

10. The method of claim 3, wherein the GBP binding features are selected from the group consisting of mean signal per glycan, signal to noise ratio, and combinations thereof.

11. A method comprising steps of
determining features of glycan structure;
correlating binding of a glycan binding protein to a plurality of glycans with the determined features present in the glycans; and
based on the correlating, determining a set of glycans bound by the glycan binding protein.

12. The method of claim 11, further including a step of a preparing a glycan-binding-protein-specific glycan array comprising the determined set of glycans.
